(19) United States
(12) Patent Application Publication
(10) Pub. No.: US 2017/0172338 A1
(43) Pub. Date: Jun. 22, 2017

(54) BEVERAGE BREWER AND RELATED METHODS FOR BREWING BEVERAGES

(71) Applicant: Remington Designs, LLC, Valencia, CA (US)

(72) Inventor: Bruce D. Burrows, Valencia, CA (US)

(73) Assignee: Remington Designs, LLC, Valencia, CA (US)

(21) Appl. No.: 15/118,473

(22) PCT Filed: Feb. 13, 2015
(86) PCT No.: PCT/US15/15971

§ 371 Date: Aug. 11, 2016

Related U.S. Application Data
(60) Provisional application No. 61/940,290, filed on Feb. 14, 2014.

(51) Int. Cl. A47J 31/057; A47J 31/44; A47J 31/36

(52) U.S. Cl. CPC A47J 31/057; A47J 31/3685; A47J 31/3695; A47J 31/4403

(57) ABSTRACT

The brewing system disclosed herein includes a spinning or rotating inlet nozzle for use in intermixing hot water and coffee in a coffee cartridge. The inlet nozzle may include one or more flow ports that inject hot water into an inner chamber of the coffee cartridge at select angles, locations and pressures to create the desired fluidized mixture of hot water and beverage medium. Such an inlet nozzle may be adapted for use in commercial coffee brewers and the amount of coffee brewed may be user regulated with an external indicator dial coupled to a controller-regulated rheostat that governs fluid flow to the brewer head by taking readings from a pump, flow meter or strain gauge.

### BACKGROUND OF THE INVENTION

The present invention relates generally to improvements in beverage brewers and related methods for brewing beverages, such as from single-serve cartridges or similar container-based coffee cartridges. More specifically, the present invention relates to beverage brewers that include an inlet nozzle that spins or rotates within a container-based beverage cartridge (e.g., one containing ground coffee) during a brew cycle to create a fluidized mixture of beverage medium and hot water therein, and relates to methods for brewing beverages related to the same.

Some types of beverage forming devices such as coffee brewers use a cartridge containing a beverage medium, e.g., ground coffee, to form a beverage. In coffee brewers of this type, water is heated by the brewer and introduced into the cartridge at the brewer head. The water infuses with the coffee in the cartridge, and the beverage formed is removed from the cartridge for consumption. Coffee brewers of this type use a stationary inlet needle that pierces the top of the cartridge and injects a relatively constant stream of hot water into the cartridge. This hot water stream may channel or tunnel through the ground coffee therein and not fully extract some grounds while over-extracting other grounds, resulting in a brewed beverage that can be bitter and can have an undesirable after taste. Coffee drinkers often try to mask this undesirable bitter taste with additives such as sugar or cream.

There exists, therefore, a significant need in the art for further improvements in and to brewing systems, and specifically for rotating, spinning or vertically oscillating an inlet nozzle within the interior of a beverage cartridge (e.g., a single-serve cartridge), wherein the rotating or spinning inlet nozzle is further able to generate a stream or spray of hot water that substantially wets and fluidizes the beverage medium therein to create a brewed beverage (e.g., a non-bitter cup of coffee). Such improvements also preferably include systems and processes for pumping water from a reservoir to a heater, determining the amount of pumped water in real-time through use of a flow control meter or the pump, and regulating the aggregate amount of pumped water based on user input from an external dial coupled to a wire-line controller, such as a rheostat, to brew a desired metered quantity of beverage. The present invention fulfills these needs and provided further related advantages.

### SUMMARY OF THE INVENTION

The beverage brewing system disclosed herein includes a water conduit system fluidly coupled to a heated water source and a brew head in fluid communication with the water conduit system and configured to selectively receive and retain a quantity of beverage medium to be brewed by heated water delivered by the water conduit system during a brew cycle. A rotatable inlet nozzle is preferably fluidly coupled with the brew head and positionable therein to selectively receive and rotatably inject heated water through at least one flow port into the quantity of beverage medium to create a fluidized mixture of hot water and beverage medium within the brew head during the brew cycle. In one embodiment, the rotatable inlet nozzle may be at least partially immersed within the quantity of beverage medium before or during the brew cycle.

In one embodiment, the rotatable inlet nozzle may include a stationary outer shaft and a rotatable central shaft, wherein the rotatable central shaft terminates into a rotating platform for dispersing heated water into the at least partially immersed quantity of beverage medium. More specifically, the rotating platform may include a set of hydraulically driven blades. In another embodiment, the flow port may include a tangential flow port, an obtusely oriented flow port, or an acutely oriented flow port to vary the flow of hot water exiting the inlet nozzle. Alternatively, the flow port may include a spiral channel, multiple flow ports staggered from one another, or a vertical flow port at least half the length of the rotatable inlet nozzle. The flow port may be configured to emit either turbulent or laminar outflow of heated water. Furthermore, the rotatable inlet nozzle may include a concave hollow nose for selectively reflectively dispersing heated water onto the surrounding beverage medium.

The beverage brewing system may further include a speed controller to change the rotational speed of the rotatable inlet nozzle and a solenoid for pivoting the rotatable inlet nozzle back-and-forth at intervals less than 360 degrees. Preferably, the brew head includes a receptacle having a size and shape for selectively receiving and retaining a single-serve brew cartridge, wherein the rotatable inlet nozzle may selectively pierce the top lid of the single-serve brew cartridge to rotatably inject hot water and/or steam to the beverage medium therein during a brew cycle. Additionally, the brewing system may include a view chamber permitting visual inspection of rotational movement of a motor operating the rotatable inlet nozzle. Viewing may be enhanced by using at least one backlit LED to illuminate the view chamber.

In another embodiment, the rotatable inlet nozzle may pivot about a hinge between a deployed position above the beverage medium or at least partially immersed within a quantity of beverage medium, and a retracted position retracted out from within the quantity of beverage medium. For example, when in the retracted position, a brew basket may selectively slide into and out from the brew head without interference with the rotatable inlet nozzle. In this respect, a controller may automatically pivot the rotatable inlet nozzle between the deployed and retracted positions to permit said sliding movement of the brew basket. Preferably, the rotatable inlet nozzle pivots between a vertical deployed position and a horizontal retracted position. Alternatively, the rotatable inlet nozzle may manually pivot about the hinge. In this embodiment, the upstanding brew basket wall may contact and pivot the rotatable inlet nozzle in one direction to permit removal thereof, and then the upstanding brew basket wall may contact and pivot the inlet nozzle in a second and opposite direction to permit re-insertion of the brew basket into the brew head. This embodiment may be particularly desirable for commercial coffee brewers.

Furthermore, a beverage brewer head disclosed herein may include a lower support member and an upper lid, wherein at least one of the lower support member or the upper lid is movable relative to the other to selectively position the beverage brewer brew head between an open position and a closed position. One of a magnet or a metal bar is disposed in the lower support member and the other of the magnet or the metal bar is disposed in the upper lid, each being respectively positioned within the lower support member and the upper lid to substantially align with one another and cooperate to lock the beverage brewer head in the closed position during a brew cycle. To this end, the lower support member and the upper lid cooperate to form a clam-shell chamber for selectively retaining a single-serve cartridge when in the closed position.

In an alternative embodiment, a series of coils may be wrapped around the metal bar and coupled to a power source, thereby forming an electromagnet having a reversible polarity. A first polarity of the electromagnet may be the same polarity as the magnet, thereby repulsing the lower support member away from the upper lid and into the open position. A second polarity of the electromagnet may include a polarity opposite the magnetic, thereby supplementing the natural attraction between the magnet and the metal bar to further attract the lower support member into engagement with the upper lid, thereby enhancing locking engagement of the brewer head in the closed position during the brew cycle. A user may depress an externally accessible button to change the polarity of the electromagnet (e.g., for purposes of opening the brew head). To this end, a feedback controller may determine whether the beverage brewer head is in the closed position or in the open position, and notify the user of the same.

In another embodiment, the beverage brewer may include a user selectable brew size. Here, the brewer may include an externally accessible brew size selector and an externally viewable indicator for displaying a selected brew size. A wire-line controller, such as a rheostat, may be responsive to selected movement of the brew size selector and preferably electrically coupled to a flow controller. The flow controller may control displacement of a desired quantity of liquid during a brew cycle commensurate in quantity with that displayed by the externally viewable indicator. In one embodiment, the flow controller preferably includes a pump that displaces water from a water reservoir to a brewer head during the brew cycle. A flow monitor may monitor the flow rate during the brew cycle, and may include a flow control meter or a pump. A user may operate the externally accessible brew size selector by way of a dial or a digital display.

In another aspect of the embodiments disclosed herein, a beverage cartridge may include a cup-shaped container generally including a bottom surface pierceable by an outlet needle, a lid pierceable by an inlet needle, and a sidewall extending therebetween. A filter is disposed within the container and subdivides the container into a first chamber containing a quantity of beverage medium and a second chamber for accommodating the outlet needle without piercing the filter. A water redirect is positioned within the interior of the container and substantially aligned with the inlet needle. The redirect preferably includes a shape and size to disperse water into the interior of the container to create a fluidized mixture of water and beverage medium during a brew cycle. In this respect, the redirect may be heat stamped to the bottom surface of the container, and include an upwardly open arcuate shape or a rotatable shaft. The rotatable shaft may include a hydraulically driven blade to facilitate water dispersion inside the cartridge.

Moreover, in other embodiments, the improved brewer system disclosed herein may include a spinning or rotating inlet nozzle that includes one or more flow ports therein for creating a fluidized mixture of coffee and hot water within the interior of a coffee cartridge, such as a single-serve coffee cartridge. In one embodiment, the inlet nozzle is used to pierce the top of a coffee cartridge and, once the brew cycle starts, a motor coupled thereto rotates the inlet nozzle 360 degrees at a predetermined rate (measured in revolutions per minute or RPMs) while immersed within the coffee grounds in the cartridge. Alternatively, the inlet nozzle may be coupled to a solenoid that rotates the nozzle a select number of degrees (e.g., 300 degrees), then rotates the inlet nozzle in the opposite direction. The inlet nozzle may continue this back-and-forth movement for the duration of the brew cycle to attain the desired sufficient intermixing of hot water and coffee. In another alternative embodiment, the inlet nozzle may vertically oscillate at a predetermined rate or variable rate during a brew cycle. In this embodiment, it is preferred that the inlet nozzle include a plurality of serrations to better agitate the beverage medium (e.g., coffee) relative to a smooth outer surface.

The inlet nozzle may include various flow ports at its nose that vary in structure and operation to adequately generate a fluidized mixture of hot water and beverage medium (e.g., coffee, hot chocolate, tea, lemonade, etc.) within the cartridge. For example, in one embodiment, hot water entering the inlet nozzle through a central shaft may reflect or bounce off an angled portion of the nozzle head to dispense out through one or more flow ports near the nose at various angles. In another embodiment, the nose of the inlet nozzle may include a flat or rigid platform that redirects incoming water flow to the surrounding beverage medium. In this embodiment, the platform may be stationary or spin about a central shaft to generate fluidization therein. Furthermore, the pressurized incoming fluid may contact one or more blades or fans coupled to the central shaft, to cause hydraulic rotation or spinning movement about the central shaft in a similar manner as if the central shaft were driven by a motor or solenoid. In this embodiment, the central shaft is driven hydraulically by the pressurized water.

Additionally, the inlet nozzle may also include one or more flow ports along its length having a structure and orientation similarly designed to generate a fluidized mixture of hot water and beverage medium within the cartridge. In this respect, the inlet nozzle may include one or more flow ports that are generally tangential to the flow of incoming water, dispense from the inlet nozzle at acute angles or dispense from the inlet nozzle at obtuse angles. In an alternative embodiment, the flow ports may include one or more elongated channel or one or more spiral channels spanning at least part of the length of the inlet nozzle, to substantially and adequately intermix hot water and beverage medium within the cartridge.

In another aspect of the beverage brewer embodiments disclosed herein, the brewer lid may include a permanent magnet designed to couple with a metal or steel bar disposed in a lower support member of a clam-shell style brewer head. Here, the permanent magnet maintains the brewer head in a closed position as a result of its magnetic attraction to the metal or other magnetic material. Although, the magnetic attraction should not be so strong that a user cannot open the brewer head for purposes of inserting or removing a coffee cartridge. In this respect, the beverage brewer may further include a controller that couples to a power source for providing electrical current to a series of coils wrapped around the exterior of the metal bar to induce a magnetic field effectively creating an electromagnet. The controller can configure the polarity of the metal bar depending on the direction of current. In one embodiment, in a resting position, the controller may provide no electrical current to the metal bar such that the magnet retains the brewer head in a closed position through non-induced magnetic attraction. Opening the brewer head may include depressing an externally accessible button that provides feedback to the controller that the user endeavors to open the brewer head. Here, the controller operates the power source to deliver electrical current to the metal bar to induce it into an electromagnet having a polarity that matches the permanent magnet. This causes the magnet and electromagnet to repel each other such that the lid moves into an open position. Similarly, the controller may operate the power source to reverse the electrical current during a brew cycle so the repulsive force changes to an attractive force to enhance attraction between the magnet and the electromagnet to ensure the brewer head remains closed during the brew cycle.

Additionally, the inlet nozzle disclosed herein may be compatible with a commercial coffee brewing system. In this embodiment, the inlet nozzle may rotate or pivot about a pin or hinge between a deployed position wherein the inlet nozzle is positioned within or above a select amount of ground coffee in a brew basket, and a non-deployed position wherein the inlet nozzle is positioned out from within the brew basket, to permit insertion and removal. When in the deployed position, the inlet nozzle may create a fluidized mixture of coffee and hot water within the brew basket, as described herein. Preferably, this is accomplished by injecting spinning or rotating water from the rotating or vertically oscillating inlet nozzle so the exiting water adequately mixes with the coffee grounds to create a fluidized mixture of hot water and coffee in the brew basket. In one embodiment, the inlet nozzle itself may rotate or spin above or at least partially immersed within the coffee grounds. Alternatively, in another embodiment, the inlet nozzle may be stationary and include a central rotating shaft that spins or rotates one or more blades or fans at one end thereof to generate the fluidized mixture of hot water and coffee. At the end of the brew cycle, the inlet nozzle automatically rotates or pivots out from within the brew basket so the preparer may quickly and easily remove the brew basket, throw away the coffee grounds and filter, insert a fresh filter and fresh coffee grounds, and reinsert the brew basket into the brew chamber for another brew cycle. A motor may automatically pivot or rotate the inlet nozzle between the deployed and retracted positions, or the inlet nozzle may be mechanically linked to insertion and/or removal of the brew basket. Alternatively, the upstanding sidewalls of the brew basket may contact and manually displace the inlet nozzle between deployed and non-deployed positions when removing or inserting the brew basket.

In yet another aspect, the beverage brewer disclosed herein may allow a user to select the quantity of beverage to be brewed in connection with a single serve or multi-serve beverage cartridge. In this embodiment, the beverage brewer may include an externally accessible brew size selector (e.g., an externally accessible dial or touch-screen interface) having an indicator for selecting a desired cup size. Movement of the brew size selector (e.g., a wire-line controller such as a rheostat) is preferably in communication with a controller that operates the flow of liquid within the brewer. In this respect, the controller may use a water pump or flow control meter to regulate or meter the amount of liquid pumped from the water source to a heater, for preparation of the brew cycle or delivery to the brew head during the brew cycle. In one embodiment, the pump may process fluid through the conduit system at a specific rate. Here, the controller monitors the duration the pump is active to determine the quantity of liquid pumped to the heater. The controller turns the pump off once the quantity of brewed beverage, as set by the user by way of the brew size selector, has been reached. In a similar manner, the pump process may be regulated or monitored by a flow control meter that provides feedback to the controller regarding the quantity of water pumped to the heater. Again, the controller stops the pump once the flow control meter provides feedback that the specific quantity of fluid has been pumped from the water source to the heater.

Other features and advantages of the present invention will become apparent from the following more detailed description, when taken in conjunction with the accompanying drawings, which illustrate, by way of example, the principles of the invention.

### BRIEF DESCRIPTION OF THE DRAWINGS

The accompanying drawings illustrate the invention. In such drawings:

FIG. 1 is a perspective view of one embodiment of a beverage brewer incorporating the improvements and related methods disclosed herein;

FIG. 2 is an alternate perspective view of the beverage brewer of FIG. 1, illustrating a lid of a brewer head in an open position;

FIG. 3 is perspective view of the brew head, further illustrating a jaw locking mechanism;

FIG. 4 is an alternate perspective similar to FIG. 3, further illustrating a jaw clip passageway and a release button of the jaw locking mechanism;

FIG. 5 is an alternate view similar to FIGS. 3 and 4, further illustrating the jaw clip and a torsion spring of the jaw locking mechanism;

FIG. 6 is an enlarged front view of the brewer head taken about circle 6 in FIG. 2, further illustrating rotation or spinning motion of an inlet nozzle;

FIG. 7 is a cross-sectional view of the brewer head taken about the line 7-7 in FIG. 2, further illustrating internal hot water flow paths through the brewer head, the inlet nozzle and a plurality of flow ports, and into an inner chamber of a container-based beverage cartridge;

FIG. 8 is a top view of the brewer head, illustrating a motor for rotating the inlet nozzle and a hot water inlet conduit coupled to the brewer head;

FIG. 9 is a cross-sectional view of the inlet nozzle taken about the line 9-9 in FIG. 6, illustrating an embodiment wherein the inlet flow of hot water is redirected off a nose of the inlet nozzle;

FIG. 10 is an alternative cross-sectional view of the inlet nozzle, illustrating a shaft-driven platform spinning and spraying inlet water flow;

FIG. 11 is another alternative cross-sectional view of the inlet nozzle, illustrating a hydraulically-driven fan or blade that spins or rotates about a shaft in response to pressurized fluid flow through the inlet nozzle;

FIG. 12 is a cross-sectional view of the inlet nozzle similar to FIG. 9, illustrating a set of horizontal flow ports for producing a tangential stream or spray of hot water;

FIG. 13 is a cross-sectional view of the inlet nozzle similar to FIGS. 9 and 12, illustrating a set of downwardly facing or acute flow ports for producing a downwardly projecting stream or spray of hot water;

FIG. 14 is a cross-sectional view of the inlet nozzle similar to FIGS. 9 and 12-13, illustrating a set of upwardly facing or obtuse flow ports for producing an upwardly projecting stream or spray of hot water;

FIG. 15 is a cross-sectional view of the inlet nozzle similar to FIGS. 9 and 12-14, illustrating a pair of horizontal flow ports, a pair of acute flow ports and a pair of obtuse flow ports for simultaneously producing a tangential, downward and upward stream or spray of hot water to be injected into the inner chamber of the brew cartridge;

FIG. 16 is an alternative cross-sectional view of the inlet nozzle similar to FIGS. 9 and 12-15, illustrating a pair of elongated channels for producing a turbulent or laminar dispersing wall of hot water exiting the inlet nozzle;

FIG. 17 is another alternative cross-sectional view of the inlet nozzle similar to FIGS. 9 and 12-16, illustrating an alternative spiral channel for injecting hot water into the coffee cartridge;

FIG. 18 is a partial schematic cross-sectional view of the brewer head having a magnetic-based locking mechanism disposed in the lid;

FIG. 19 is a schematic view illustrating an alternative embodiment wherein the rotating or spinning inlet nozzle disclosed herein is adapted for use in a commercial coffee brewer, and shown in a deployed position;

FIG. 20 is a schematic view similar to FIG. 19, further illustrating the inlet nozzle pivoted to a non-engaged position wherein a brew basket may be inserted or removed from a brew chamber without interference;

FIG. 21 is a schematic view similar to FIGS. 19 and 20, further illustrating manual pivoting of the inlet nozzle from the deployed position shown in FIG. 19 through contact with an upstanding brew basket wall, to permit manual removal of the brew basket from the brew chamber;

FIG. 22 is a schematic view similar to FIG. 21, further illustrating manual pivoting of the inlet nozzle from the deployed position shown in FIG. 19 through contact with the upstanding brew basket wall, to permit manual insertion of the brew basket into the brew chamber;

FIG. 23 is a schematic view illustrating a coffee brewing system having an externally accessible dial that permits user selection of a specific quantity of beverage to be brewed in accordance with the embodiments disclosed herein and a controller for regulating the quantity of brewed beverage in response thereto;

FIG. 24 is a top plan view of the brewer head lid, illustrating a transparent motor chamber having a plurality of backlit LEDs illuminating motor movement therein;

FIG. 25 is a cross-sectional view of a beverage cartridge incorporating a redirect for dispersing incoming water flow into the inner chamber in an embodiment wherein the inlet nozzle may not spin or rotate;

FIG. 26a is a cross-sectional view of the brewer head taken about line 26-26 in FIG. 1, further illustrating the relative positioning of a locking solenoid relative to a jaw clip, in the non-engaged position;

FIG. 26b is a cross-sectional view similar to FIG. 26a, further illustrating partial deployment of an extendable shaft from the locking solenoid behind the jaw clip and externally accessible button;

FIG. 26c is a cross-sectional view similar to FIGS. 26a and 26b, further illustrating full deployment of the extendable shaft behind the jaw clip and externally accessible button to lock the brew head in a closed position;

FIG. 27 is a cross-sectional view of the brewer head similar to FIG. 7, illustrating an alternative embodiment of a vertically oscillating inlet nozzle; and

FIG. 28 is a cross-sectional view similar to FIGS. 9 and 12-17, illustrating an alternative inlet nozzle having serrations along its external periphery.

### DETAILED DESCRIPTION OF THE PREFERRED EMBODIMENTS

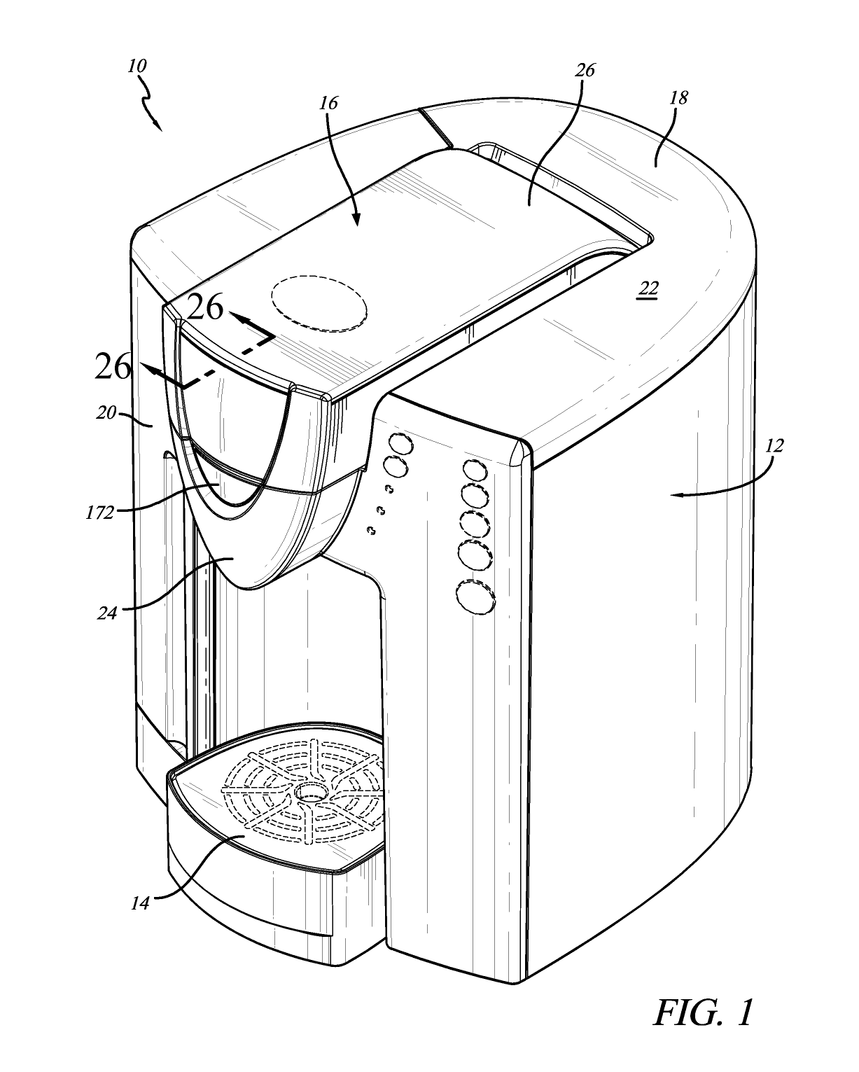

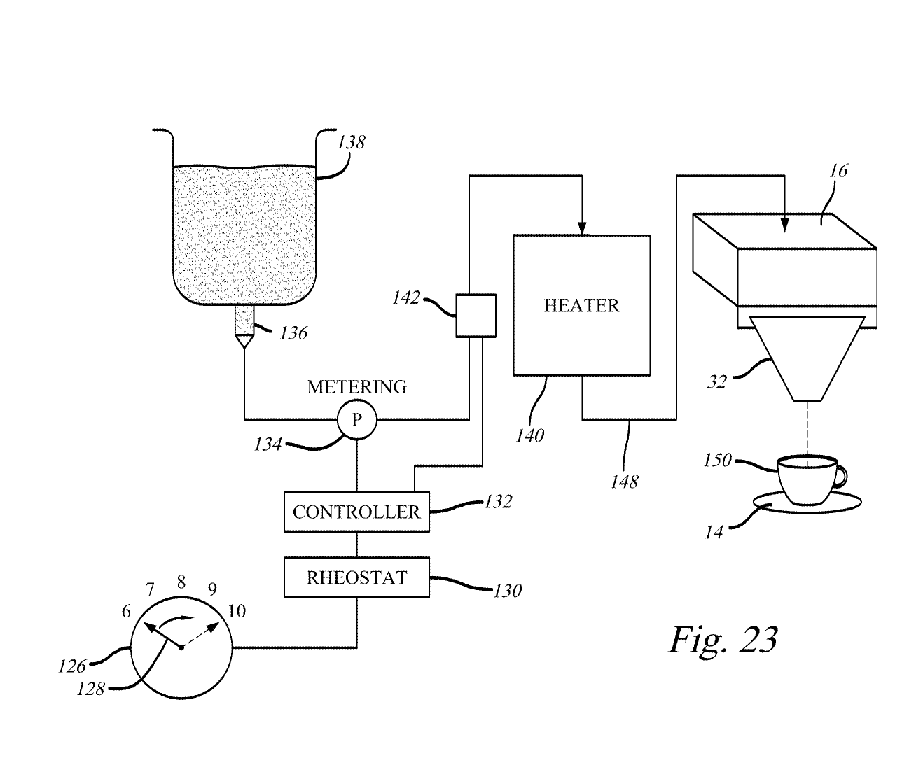

As shown in the drawings for purposes of illustration, the present disclosure for an improved beverage brewer is referred to generally as reference numeral 10 in FIGS. 1-2 and 8. In general, the improved beverage brewer 10 disclosed herein is designed for use with container-based beverage cartridges, such as single-serve coffee cartridges like the Keurig K-cup® manufactured by Green Mountain Coffee Roasters, Inc. of 33 Coffee Lane, Waterbury, Ver. 05676. In general, as shown in FIG. 1, the beverage brewer 10 may include a generally upright housing 12 having a base or platen 14 extending out at the bottom and positioned generally below an outwardly extending brewer head 16. The vertical distance between the platen 14 and the brewer head 16 should adequately accommodate a coffee mug or the like capable of retaining at least 6 oz. of beverage, and possibly 10 oz. or more of beverage. The housing 12 further includes a rear housing 18 having a gravity-fed water reservoir 20 on one side and an outer shell 22 that houses or protects the internal features of the brewer 10, including, for example, the conduit system between the water reservoir 20 and the brewer head 16. Such features within the housing 12 of the beverage brewer 10 also preferably generally include at least a fluid conduit system and heating element (shown schematically in FIG. 23).

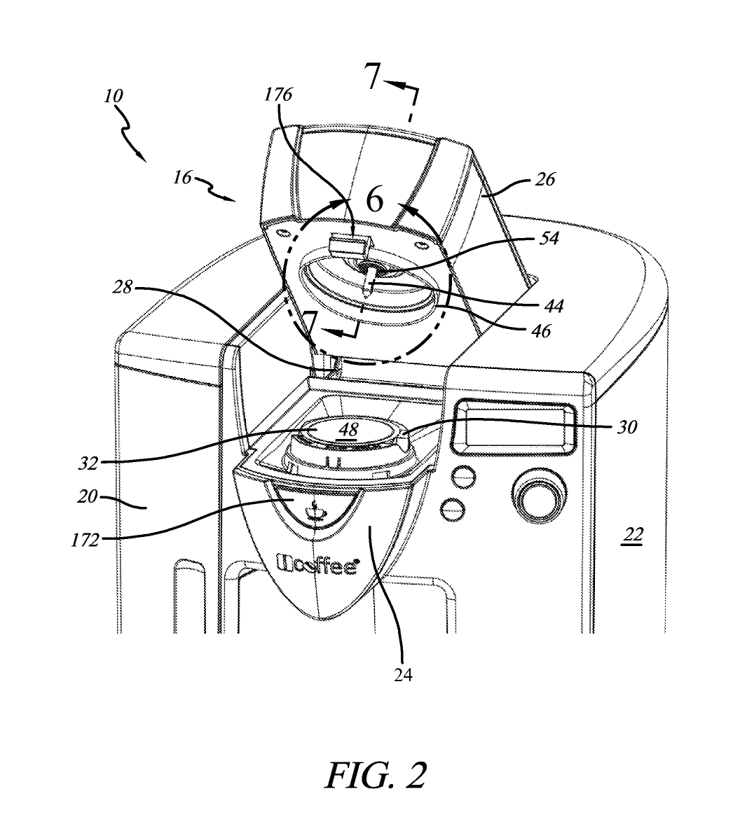

FIG. 2 is an alternative perspective view of the brewer head 16 having a preferably clam-shell structure that includes a stationary lower support member 24 and a movable upper member or lid 26 that pivots relative to the lower support member 24 about a hinge 28. Although, a person of ordinary skill in the art will readily recognize that the lower support member 24 and the lid 26 may both be movable, or that the lower support member 24 may be movable relative to a stationary lid 26. Additionally, the lower support member 24 and the lid 26 may pivot or rotate about the common hinge 28, or separate hinges or points (not shown). The lower support member 24 and the lid 26 are used in concert to form a brew chamber therebetween during a brew cycle for selective retention of a receptacle 30 and a beverage cartridge 32 therein (FIG. 2). The beverage cartridge 32 may include any beverage medium known in the art, including, but not limited to, beverage medium used to brew various types of coffee, espresso, tea, hot chocolate, lemonade and other fruit-based drinks, carbonated drinks, such as soda, etc.

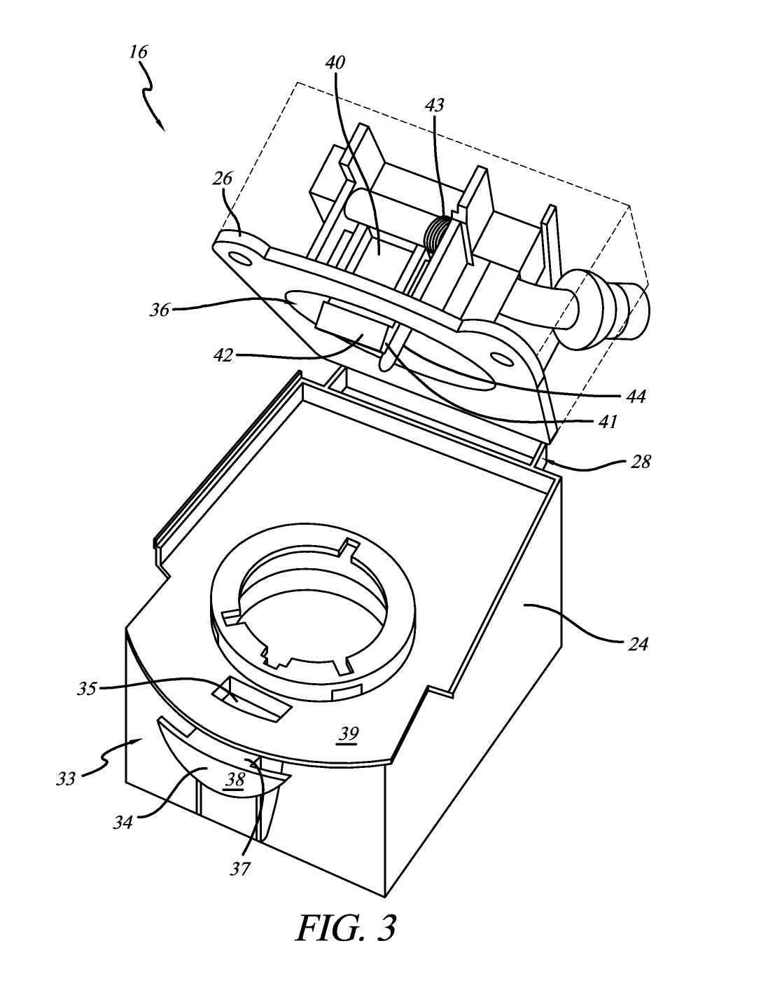

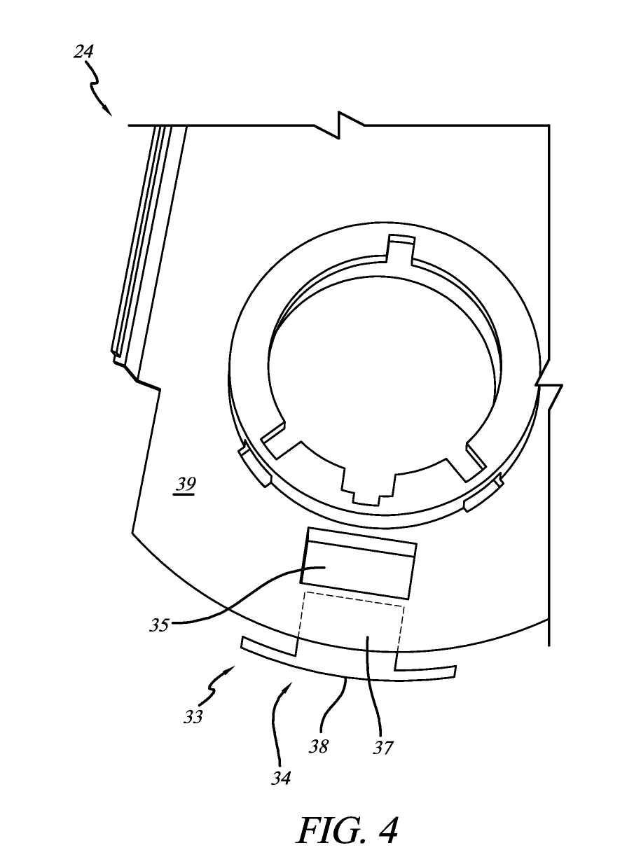

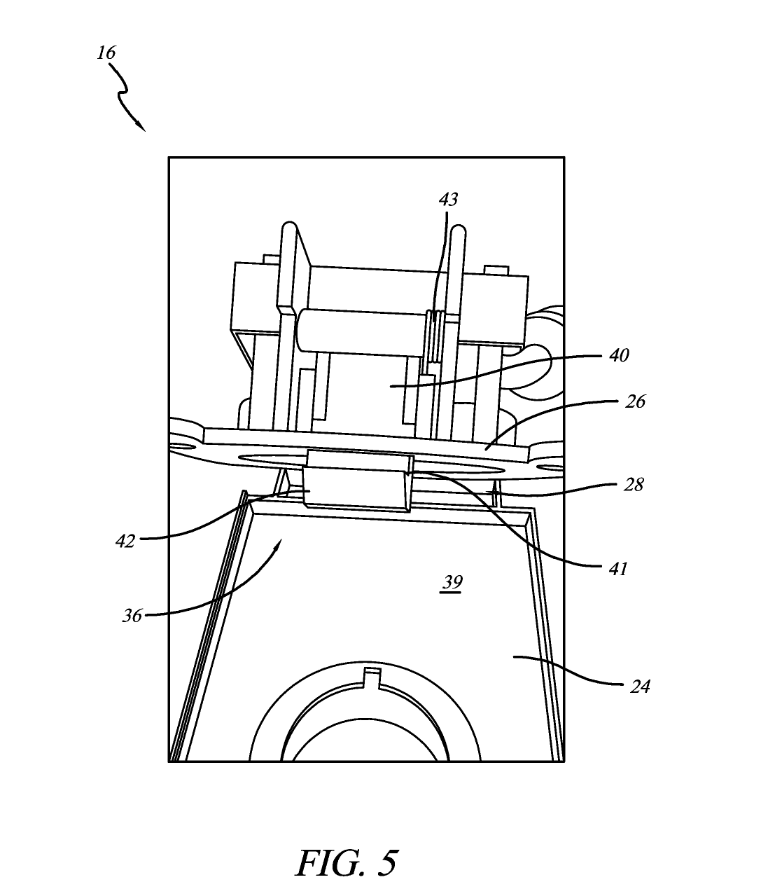

In this respect, FIG. 1 illustrates the lid 26 engaged with the lower support member 24 such that the brewer head 16 is in the closed or locked position. A jaw lock 33 best illustrated in FIGS. 3-5 preferably includes a forwardly and externally accessible release button 34 protruding from a portion of the brew head 16 and configured for hand manipulation. When depressed, the release button 34 selectively slides horizontally within a jaw clip passageway 35 disposed in the lower support member 24. In general, movement of the release button 34 into the jaw clip passageway 35 engages a jaw clip 36 residing therein when the brewer head 16 is in the closed position shown in FIG. 1. The jaw clip 36 is pivotably mounted to the lid 26 such that engagement of the release button 34 causes rearward pivotable movement of the jaw clip 36 within the jaw clip passageway 35 for disengagement therefrom such that the lid 26 is able to pivot away from the lower support member 24.

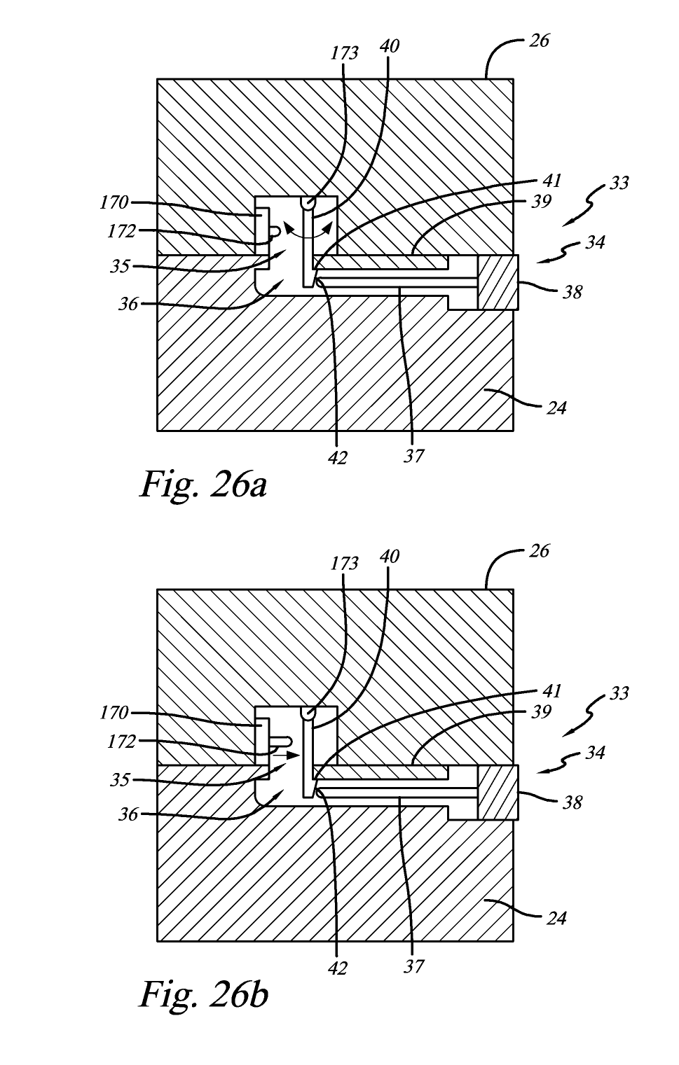

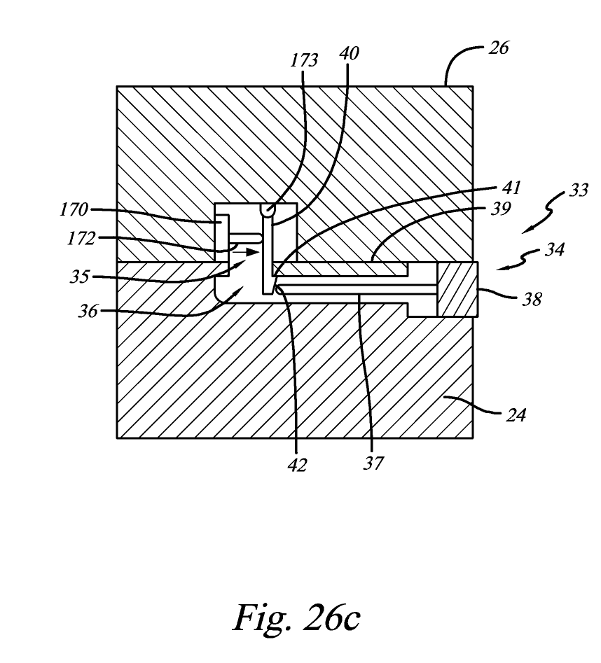

More specifically, the release button 34 includes a release button shaft 37 extending into the lower support member 24 and away from an externally accessible finger-actable touch surface 38. The release button 34 is biased in the outward direction (i.e., the non-depressed position), such as by a spring (not shown) or the like. The jaw clip passageway 35 is preferably an aperture generally formed downwardly from a top surface 39 of the lower support member 24 that provides mechanical communication with the release button shaft 37. In this respect, the release button shaft 37 can slide or extend into and out from the jaw clip passageway 35 through depression of the release button 34, against resistance of the release button spring or the like. The jaw clip 36 includes a jaw clip shaft 40 having a boss 41 disposed on a lower end thereof and extending perpendicularly therefrom. The boss 41 further includes a downward facing chamfer 42 (i.e., the top of the boss 41 is preferably thicker than the bottom) for guiding the jaw clip 36 into locking engagement with the lower support member 24 by way of the jaw clip passageway 35. When the brew head 16 is closed, the jaw clip 36 extends down in the jaw clip passageway 35. A torsion spring 43 biases the jaw clip 36 in a forward position (i.e., the jaw clip 36 is pivoted toward the touch surface 38), thereby pushing the boss 41 forward within the passageway 35 and underneath the top surface 39 of the lower support member 24 and next to the release button shaft 37 (shown best in FIGS. 26a-26c). In this respect, the contact between the lower support member 24 and the boss 41 holds the brew head 16 closed as shown in FIG. 1.

To open the brew head 16, the user depresses the touch surface 38, thereby causing the release button shaft 37 to slide horizontally into the jaw clip passageway 35 and into contact with the boss 41 therein. This horizontal sliding force pivots the boss 41 against the forward force of the torsion spring 43 and out from engagement with the jaw clip passageway 35. In this respect, the release button shaft 37 effectively rotates the jaw clip 36 to a position where the boss 41 is disposed entirely within the opening of the jaw clip passageway 35 and out from underneath the top surface 39 of the lower support member 24 as shown in FIGS. 26a-26c. Accordingly, since no surface is present above the boss 41, the lid 26 is able to pivot away from engagement with the lower support member 24, thereby opening the brew head 16 as shown in FIG. 2. In this position, a user may selectively insert or remove the beverage cartridge 32.

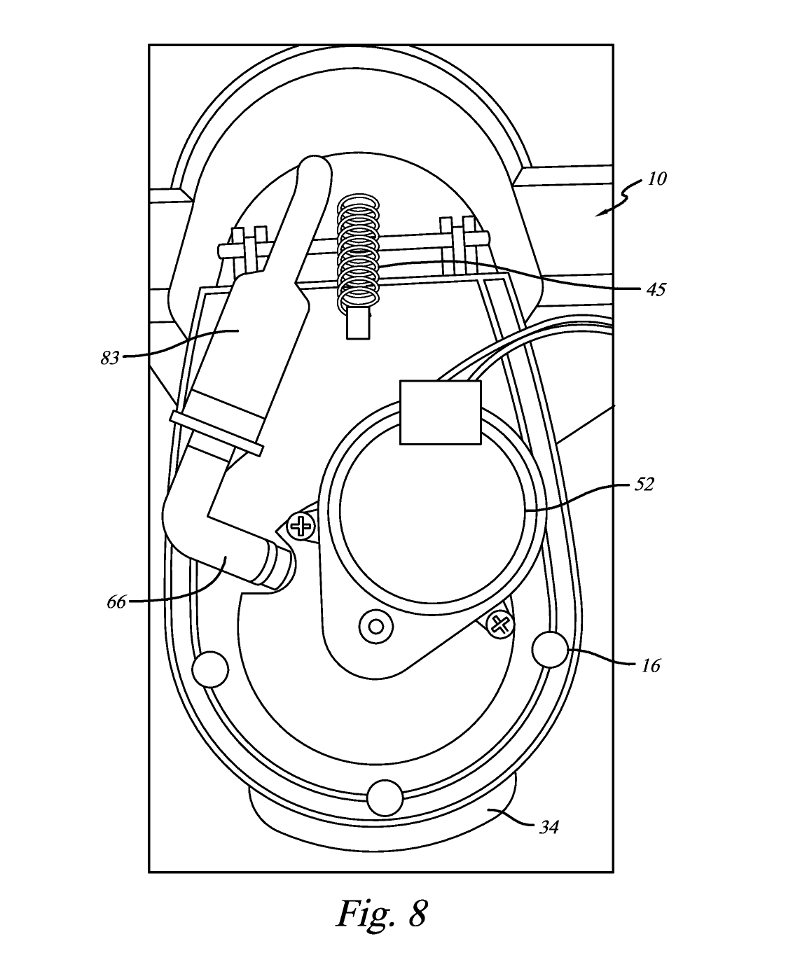

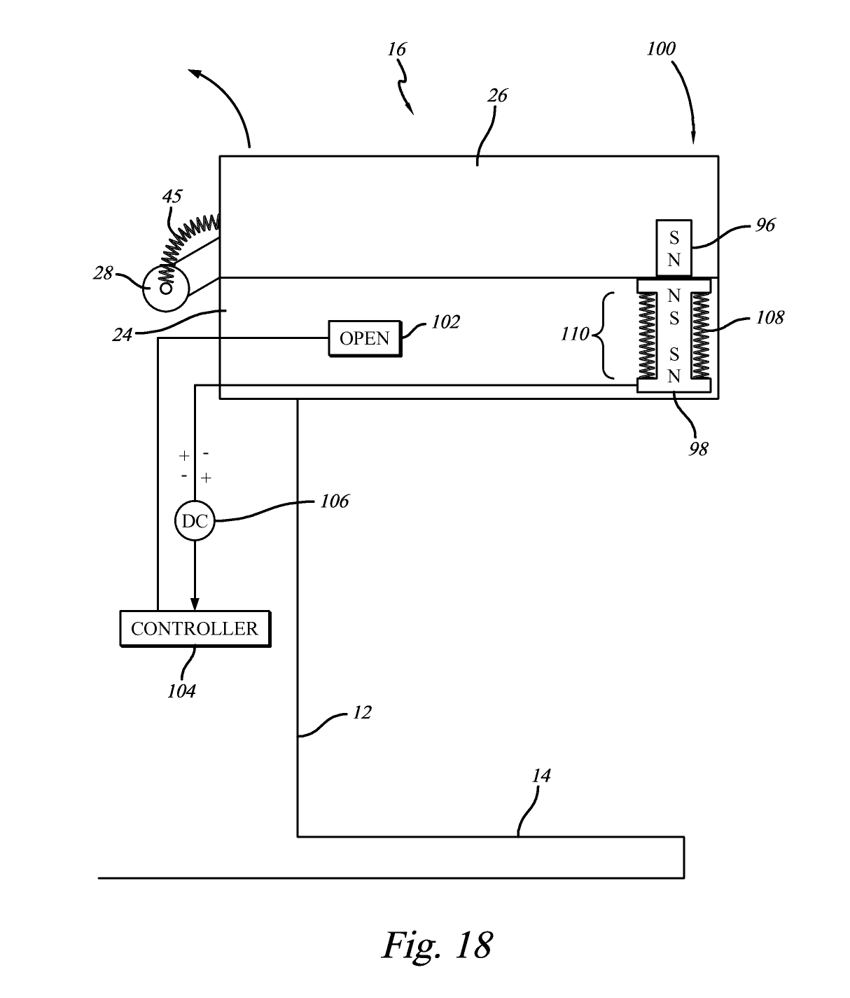

Furthermore, with respect to FIGS. 2 and 6, the beverage brewer 10 also includes an inlet nozzle 44 that generally extends downwardly out from underneath the lid 26, as shown. The inlet nozzle 44 is in fluid communication with a conduit system (described in more detail below) for injecting turbulent or laminar hot water and steam into the beverage cartridge 32. As mentioned above, to prepare the beverage brewer 10 for a brew cycle, the lid 26 is released from the lower support member 24 through depression of the release button 34 so a spring 45 (FIGS. 8 and 18) causes the lid 26 to rotate counter-clockwise to the open position shown in FIG. 2. When in this position, the beverage cartridge 32 can be inserted into the receptacle 30 (shown empty in FIGS. 3-5; and containing the beverage cartridge 32 in FIG. 2). The lid 26 of the beverage brewer 10 is then pushed downward against the opening force of the spring 45 such that the jaw clip 36 slides back into the passageway 35 wherein the boss 41 reengages underneath the top surface 39 of the lower support member 24 to lock the lid 26 to the lower support member 24 in the position shown in FIG. 1. The lid 24 may include an encapsulation cap 46 having a diameter sized for at least partial slide-fit insertion over the receptacle 30 to encapsulate and retain the beverage cartridge 32 therebetween.

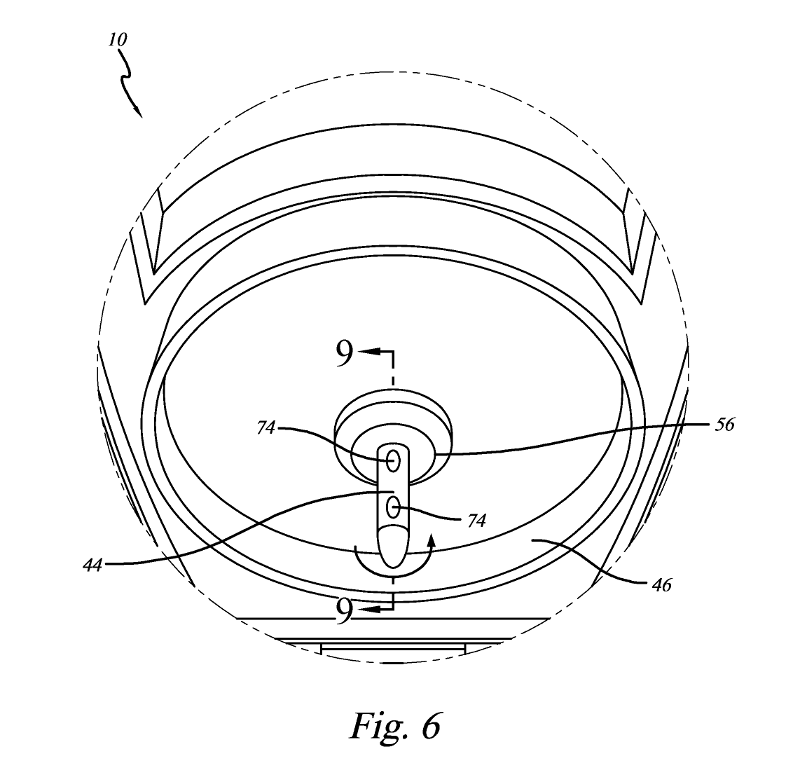

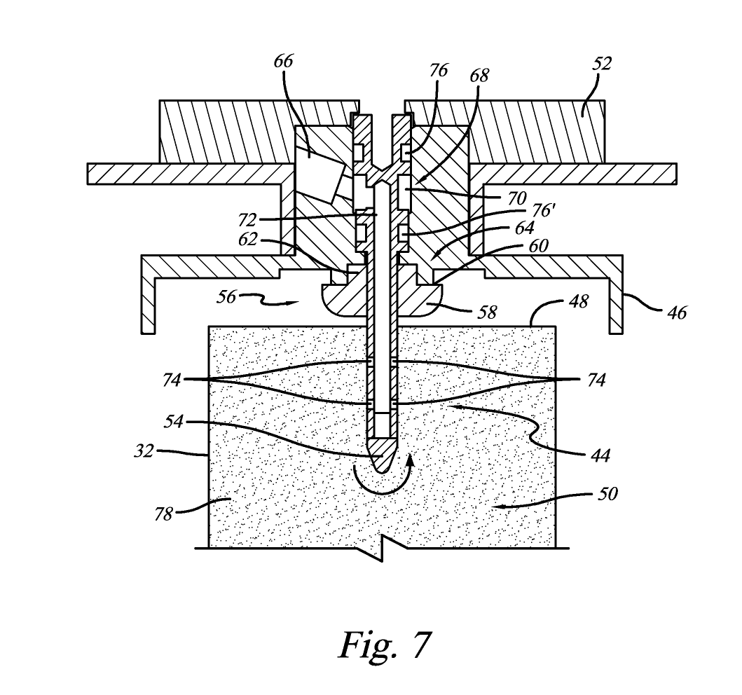

When the lid 26 is pivoted to the closed position shown in FIG. 1, the inlet nozzle 44 moves to a position to puncture an outer surface 48 of the beverage cartridge 32 and extend down into an inner beverage medium-filled chamber 50 (FIG. 7) of the beverage cartridge 32. When in this position, the inlet nozzle 44 may be rotated by a motor 52 coupled thereto. The same or different motor may also selectively vertically move or position the inlet nozzle 44. The inlet nozzle 44 described herein preferably includes a blunt or rounded nose 54 that force pierces the surface 48 to permit entry of the inlet nozzle 44 into the interior of the beverage cartridge 32. Of course, such a nose could be sharpened (e.g., with jagged edges) as known in the art, but such a sharp or jagged edge is less preferable since it carries an inherently higher risk of user injury when the inlet nozzle is exposed (e.g., as shown in FIG. 2). The brewer head 16 may further include a gasket 56 (e.g., made from rubber) having a concentric aperture with an inner diameter sized to snugly slide-fit around the exterior surface diameter of the inlet nozzle 44. One preferred gasket 56 is shown in FIG. 7 with a generally larger mushroom-shaped head 58 forming a ledge or step 60 that has a relatively smaller diameter neck 62 preferably having an outer diameter sized for snug slide-fit reception into a corresponding aperture 64 in the brewer head 16 permitting extension of the inlet nozzle 44 as shown. In this respect, the gasket 56 pressure seals the inlet nozzle 44 relative to the interior of the brewer head 16 and related hot water conduit system.

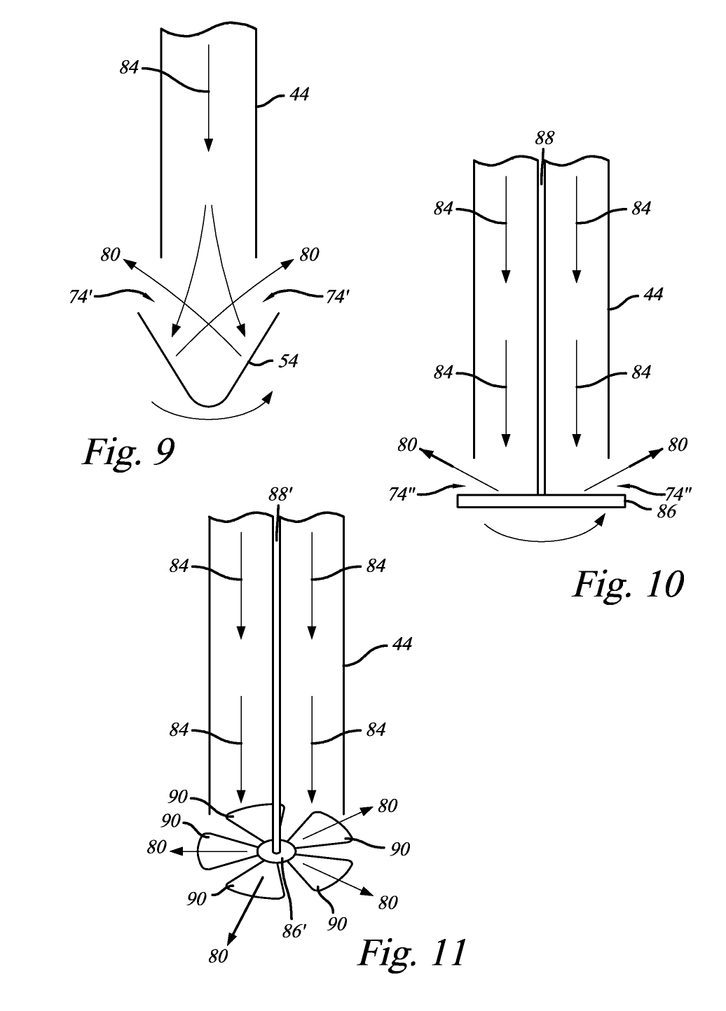

As further shown in FIG. 7, a hot water conduit 66 terminates at an upper end 68 of the inlet nozzle 44 and is aligned with an inlet channel 70 bored into the exterior diameter of the inlet nozzle 44 and in fluid communication with a central shaft 72 that channels hot water from the upper end 68 down toward the nose 54 and out through one or more flow ports 74. Preferably, two O-rings 76, 76′ are positioned on each side of the inlet channel 70 to prevent leakage from pressurized hot water leaving the hot water conduit 66 for flow into the inlet channel 70. The inlet channel 70 is preferably a reduced diameter bore that remains in fluid communication with the hot water conduit 66 during the entire brew cycle, even as the inlet nozzle 44 spins or rotates as described herein. Accordingly, in this arrangement, a motor 52 couples to the upper end 68 and rotates or spins the inlet nozzle 44 during a brew cycle to rotate or spin the one or more flow ports 74 within the beverage cartridge 32 to more thoroughly create a fluidized mixture of hot water and beverage medium 78 therein during the brew cycle. The embodiment shown in FIG. 7 illustrates the use of four flow ports 74, but the inlet nozzle 44 may have as few as one flow port 74. The ports 74 may be structured to inject hot water into the beverage cartridge 32 in a variety of different ways, as described in more detail below with respect to FIGS. 9-17, including an upward stream or spray and/or a downward stream or spray. Rotational movement of the inlet nozzle 44 and the injection stream or spray of hot water from the nozzle 44 is capable of creating a fluidized mixture of hot water and coffee within the interior of the beverage cartridge 32. In this respect, the beverage brewer 10 described herein prevents channeling and over exposure of beverage medium (e.g., coffee grounds) during the brew cycle. At least with respect to coffee, this effectively substantially eliminates the bitter taste often associated with single-serve coffee brewers known in the art and rotation of the inlet nozzle 44 within the beverage medium 78 also produces a noticeable layer of coffee crema after the brewed coffee dispenses from the brewer head 16.

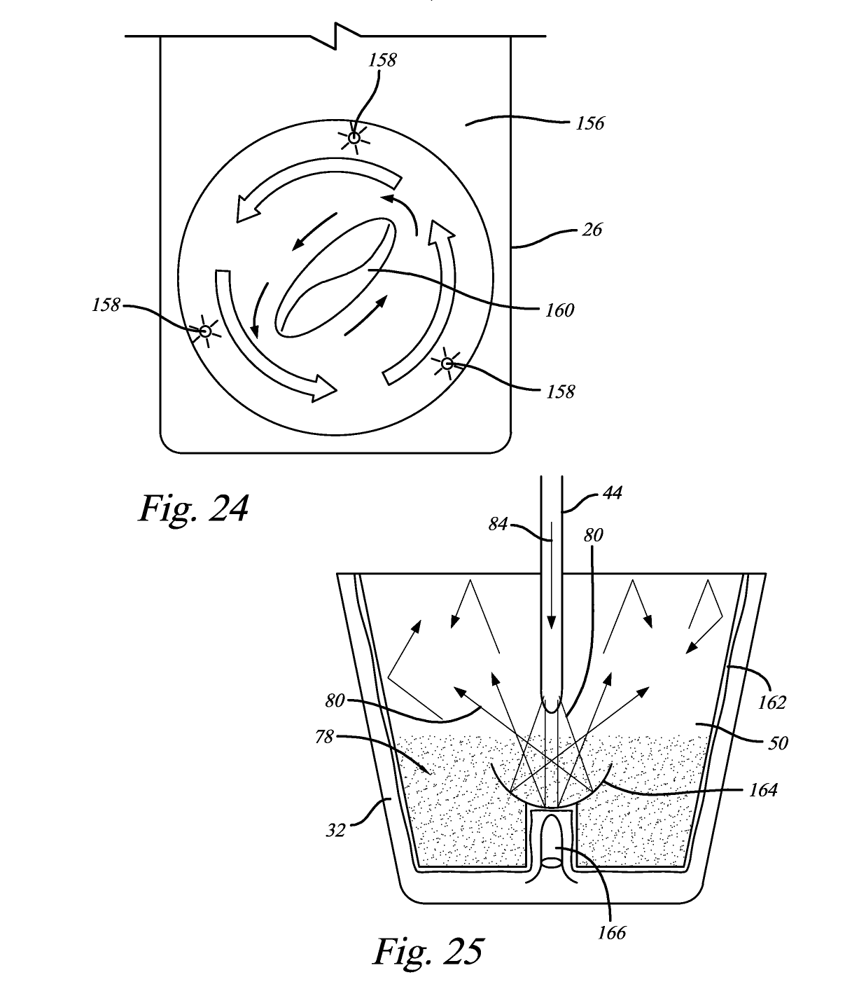

Furthermore, FIG. 8 is a top view of the brewer head 16 illustrating a top mounted motor 52 that may be used to rotate the inlet nozzle 44 (not shown in FIG. 8) 360 degrees at a constant speed (typically measured in revolutions per minute, or RPMs) or at variable speeds (e.g., higher RPMs when the brew cycle first initiates and relatively slower RPMs closer to the end of the brew cycle, or vice versa). Alternatively, the motor 52 may only partially rotate or pivot the inlet nozzle 44 (e.g., 300 degrees), then stop and reverse rotation an opposite 300 degrees. This same partial rotational feature may also be accomplished through use of a solenoid (not shown), as opposed to the motor 52. In FIG. 8, the motor 52 is shown next to the entry point of the hot water conduit 66. In this embodiment, hot water flow to the coffee brewer head 16 may be regulated by a solenoid 83. FIG. 8 also illustrates the extension spring 45 coupled within the interior of the lid 26, which endeavors to pivot the lid 26 from the closed position shown in FIG. 1 to the open position shown in FIG. 2 when the jaw clip 36 is released, as described above. In one embodiment illustrated in FIG. 24, the motor 52 may be mounted underneath a clear housing 156 or visible within a chamber to permit visual inspection of the motor rotation during a brew cycle. Furthermore, this clear housing 156 may be backlit with a plurality of lights 158 and include a graphic 160 to indicate the brew cycle is active and that the inlet nozzle 44 is spinning or rotating.

FIGS. 9-11 illustrate additional alternative embodiments for injecting incoming hot water and steam into the inner chamber 50 of the beverage cartridge 32 during a brew cycle. For instance, FIG. 9 illustrates a pressurized hot water flow 84 flowing through the interior of the inlet nozzle 44 toward the nose 54. In this embodiment, the pressurized hot water flow 84 contacts an angled or concave interior portion of the nose 54 as shown and is ejected out therefrom as the stream or spray 80 through one or more of the flow ports 74′. In this respect, a person of ordinary skill in the art will readily recognize that the interior of the nose 54 can be shaped as desired to obtain the desired direction and intensity of directional outflow or spray 80. As described above, the inlet nozzle 44 may rotate about its axis so the stream or spray 80 fluidizes and rotates the beverage medium 78 (e.g., ground coffee) in the beverage cartridge 32.

Similarly, FIG. 10 illustrates an alternative embodiment wherein the shaft of the inlet nozzle 44 is stationary and includes a spinning or rotating platform 86 designed to disperse the incoming flow 84 into the aforementioned stream or spray 80. In this embodiment, the platform 86 may include a shaft 88 coupled to the motor 52 and driven at a constant or variable rate (RPM) to attain substantial rotational fluidized mixture of the hot water and beverage medium 78 in the beverage cartridge 32. Alternatively, as shown in FIG. 11, a modified platform 86′ may include one or more straight or angled fans or blades 90 attached or otherwise extending therefrom and configured to be hydraulically-driven by the pressurized hot water flow 84 travelling through the interior of the inlet nozzle 44. In this embodiment, the hot water flow 84 contacts the blades 90 and causes the modified platform 86′ to spin about its shaft 88′ in a comparable manner as if driven by the motor 52. This embodiment may be preferred as a mechanism for saving energy related to the installation, use and power of the aforementioned motor 52.

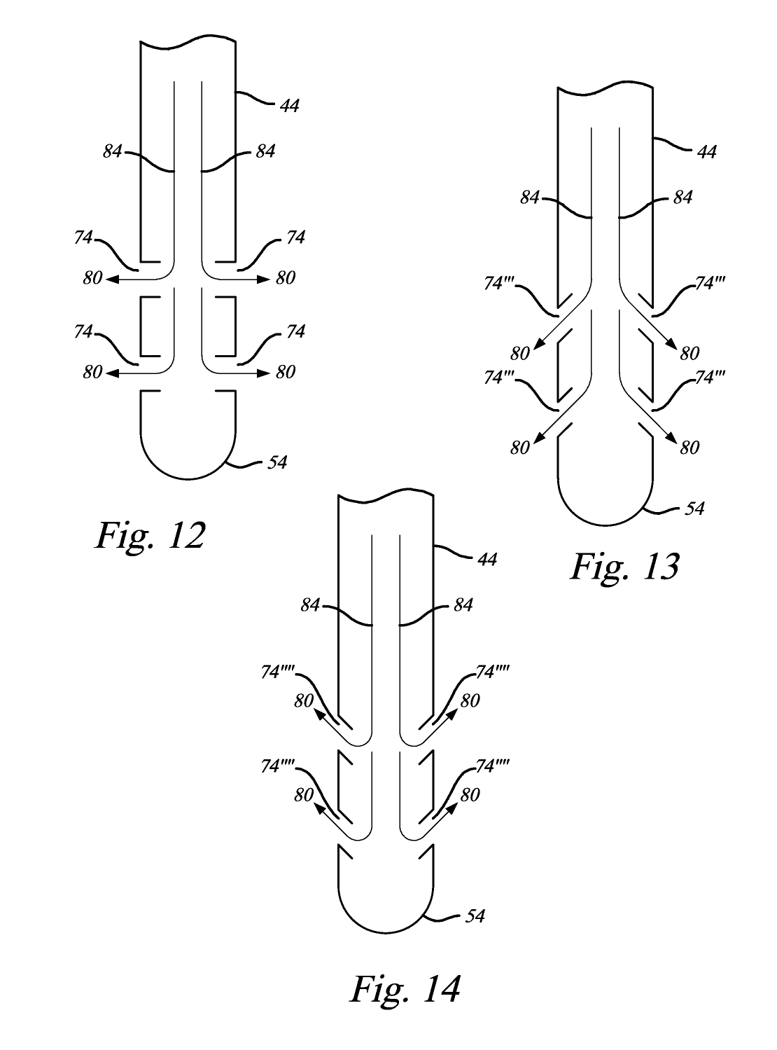

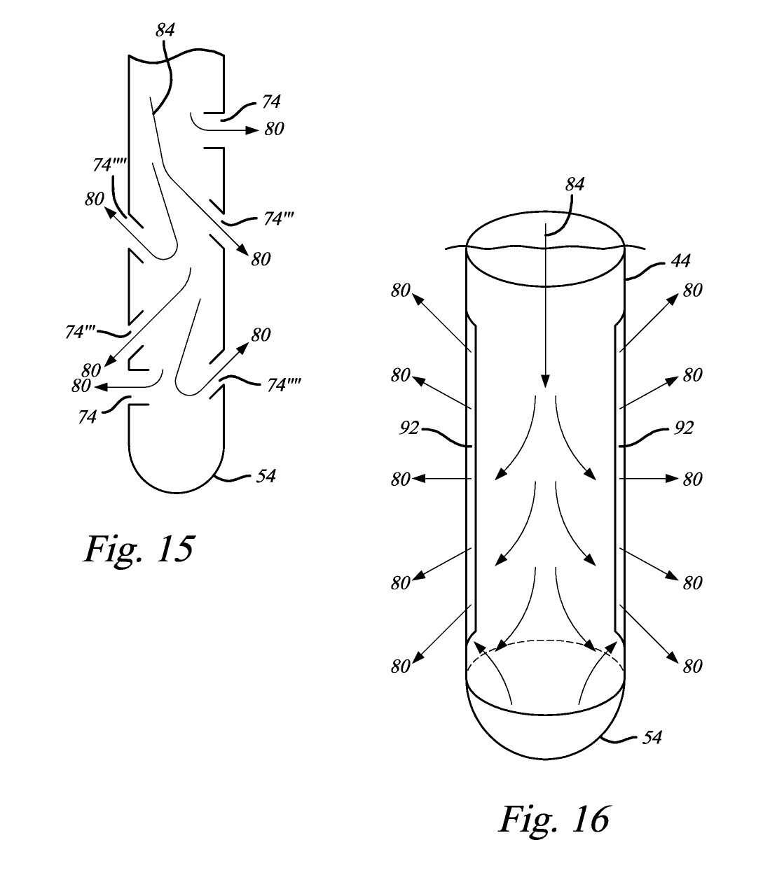

Furthermore, FIGS. 12-17 illustrate the inlet nozzle 44 having various different flow paths or flow ports for delivering hot water and steam into the inner chamber 50 of the beverage cartridge 32. For example, FIG. 12 illustrates one embodiment wherein four flow ports 74 are positioned generally horizontal and perpendicular to the vertical length of the inlet nozzle 44 and generally opposite one another, similar to FIG. 7. Here, the stream or spray 80 exiting the inlet nozzle 44 is generally tangential. FIG. 13 illustrates an alternative embodiment wherein four flow ports 74″′ channel the flow 84 out from the inlet nozzle 44 at an acute angle. Of course, this discharge angle could vary between the generally tangential flow (e.g., 90 degree turn) shown in FIG. 12 and near parallel flow (e.g., on the order of 5 or 10 degrees) as better shown in FIG. 13 (not to scale). The discharge angle of the flow ports could, of course, be the reverse of the acute angles shown in FIG. 13. In this respect, FIG. 14 illustrates one embodiment wherein a plurality of flow ports 74″″ are oriented to direct the stream or spray 80 in an upward manner at angles larger than 90 degrees relative to the incoming flow 84, and upwards of 170 or 175 degrees relative to the incoming flow 84. Alternatively, the inlet nozzle 44 could include a mixture of the flow ports 74-74″″ as shown in FIG. 15. Here, the inlet nozzle 44 includes a pair of the horizontal flow ports 74 that produce tangential outward flow of the stream or spray 80, a pair of the downwardly facing or acute flow ports 74″′ that direct the stream or spray 80 in a downward or acute manner relative to the flow 84, and a pair of upwardly facing or obtuse flow ports 74″″ that direct the stream or spray 80 in an upward or obtuse manner relative to the flow 84. Of course, each of the flow ports 74-74″″ can be mixed and matched as desired along the length of the inlet nozzle 44 or the nose 54 to attain the desired outward flow of hot water to adequately mix and fluidize the beverage medium 78 within the cartridge 32 during the brew cycle. The pressure delivered to the flow ports 74-74″″ can also be constant or variable during the course of the brew cycle.

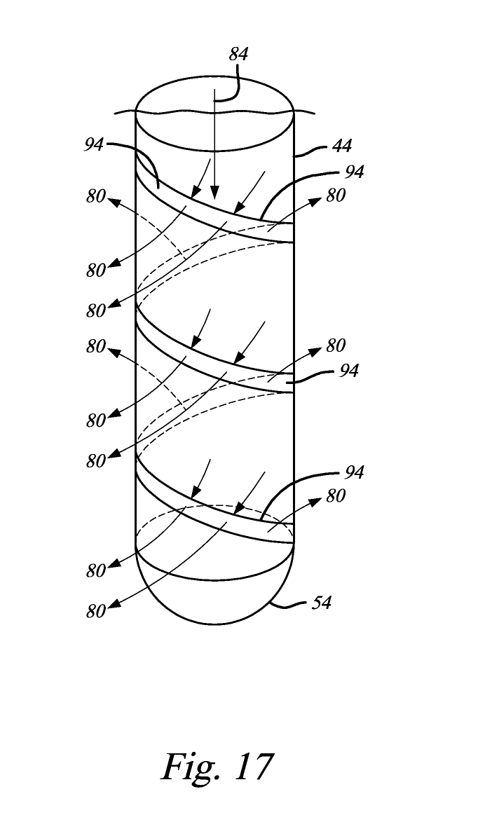

FIGS. 16 and 17 illustrate alternative embodiments similar to the flow ports 74-74″″ describe above. In this respect, FIG. 16 illustrates one embodiment wherein the flow ports are elongated and form one or more exit channels 92. The exit channels 92 may be particularly preferred to attain a wider or open flow of the stream or spray 80 as shown in FIG. 16. Preferably, the elongated channel 92 tracks the vertical height of the beverage cartridge 32 by as little as 50% of its height and by as much as 95% of its height. Furthermore, the elongated channels 92 may be centered within the inner chamber 50, but the channels 92 may also be at a staggered height relative to the cartridge sidewalls or relative to each other if more than one channel 92 is used in the inlet nozzle 44. As shown in FIG. 16, the elongated channel 92 may be able to better disperse laminar or turbulent hot water into the chamber when the inlet nozzle 44 rotates or spins, as described above. In another embodiment, the flow port could be in the form of a downwardly extending spiral channel 94 that generally tracks the outer periphery of the inlet nozzle 44 as shown in FIG. 17.

Of course, the number and orientation of the flow ports 74-74″″, the elongated channels 92 and the spiral channel 94 could be mixed and matched as needed, to obtain the desired stream or spray 80 exiting the inlet nozzle 44. For instance, the flow ports 74-74′ or the channels 92,94 could be staggered, positioned opposite one another, or positioned at various angles (e.g., every 30, 60 or 90 degrees).

In another aspect of the beverage brewer 10 disclosed herein, FIG. 18 is a schematic view of an alternative mechanism for selectively opening and/or closing the brewer head 16. In the preferred embodiment, the lid 26 includes a magnet 96 (e.g., a permanent magnet) disposed toward the front of the lid 26, such as in the general location of where the jaw lock 33 is located in FIGS. 3-5. In this embodiment, of course, the jaw lock 33 is unneeded. In this respect, in the closed position shown in FIG. 18, the magnet 96 is positioned to magnetically attract to a metal bar 98 (e.g., made from steel or stainless steel) disposed within a portion of the lower support member 24. Accordingly, to close the lid 26, one need only apply a force to the top of the lid 26 along a directional arrow 100 so the magnet 96 enters into magnetic attraction with the metal bar 98. The magnetic attraction between the magnet 96 and the bar 98 is stronger than the opening force of the extension spring 45, which is designed to pull open the lid 26 about the hinge 28, as described above.

In the preferred embodiment, to open the lid 26, a user may select or depress an “Open” button 102 or another externally accessible comparable sensory feedback device in communication with a brewer controller 104 that operates the various brewing functions of the beverage brewer 10. When the controller 104 identifies that the open button 102 has been selected or depressed, the controller 104 may communicate with a power source 106, such as a direct current (“DC”) or alternating current (“AC”) power supply, to generate electric. In this respect, the metal bar 98 may include a series of coils 108 coupled to the power source 106 and, when combined with the metal bar 98, effectively creates an electromagnet 110 when powered. In this respect, in a preferred embodiment, the metal bar 98 may not have a defined polarity when the beverage brewer 10 is “off” or idle. To open the lid 26, pushing the open button 102 induces feedback communication to the controller 104 to activate the power source 106 in a manner that induces current to the coils 108 to create the electromagnet 110 with a polarity common to the magnet 96. In this state, the “north” (or “N”) polarity of the magnet 96 may align with the “north” (or “N”) polarity of the electromagnet 110, and vice versa, thereby generating a repulsive force that pushes the lid 26 away from the lower support member 24 about the hinge 28. This repulsive force supplements the force of the spring 45, which tends to generally bias open the lid 26 so the brewer head 16 is in the open position as shown and described above with respect to FIG. 2. To save energy, the power source 106 may only deliver energy to the coils 106 for a short duration, e.g., less than a few seconds, and preferably for only a fraction of a second to permit disengagement of the magnet 96 from the bar 98. In this respect, the controller 104 may include a feedback mechanism for determining whether the brewer head 16 is in the open position (FIG. 2) or in the closed position (FIGS. 1 and 18). When in the option position shown in FIG. 2, the user may insert the beverage cartridge 32 into the receptacle 30, as described above, in preparation for a brew cycle.

To close the brewer head 16, one need only apply a force along the directional arrow 100, which causes the lid 26 to rotate clockwise about the hinge 28 so the magnet 96 can reengage with the metal bar 98. The spring 45 naturally resists such clockwise movement. The magnet 96 preferably magnetically attracts to the metal bar 98 when positioned proximate thereto. As mentioned above, the feedback mechanism may relay to the controller 104 that the brewer head 16 is, again, in the closed position and ready to execute the brew cycle, especially if the controller 104 can automatically identify the existence of the beverage cartridge 32 in the receptacle 30. To this end, the controller 104 may be configured to automatically start the brew cycle, or further prompt the user to execute the brew cycle by way of selection of an externally accessible “brew” button (not shown).

When the brew cycle starts, the controller 104 may simultaneously (or shortly before) communicate with the power source 106 to generate current deliverable to the coils 108 to ensure that the lid 26 remains tightly engaged with the lower support member 24. In this respect, during the brew cycle, the power source 106 may generate current to the coils 108 to induce the electromagnet 110 to produce a reverse polarity between the magnet 96 and the metal bar 98. In this state, the “north” (or “N”) polarity of the magnet 96 aligns with the “south” (or “S”) polarity of the electromagnet 110, thereby generating an attractive force between the two—a force that causes the lid 26 to remain in tight contact with the lower support member 24. This attractive force supplements the natural attractive force between the magnet 96 and the metal bar 98, when the metal bar 98 is not being induced as an electromagnet. Accordingly, the brewer head 16 preferably stays in the closed position (e.g., as shown in FIGS. 1 and 18) for the duration of the brew cycle and naturally prevents a user from inadvertently opening the brewer head 16 until completion of the brew cycle. When the brew cycle completes, the controller 104 may turn the power source 106 “off” so the metal bar 98 is no longer magnetically induced as an electromagnet. When in this condition, the magnet 96 will remain magnetically attracted to the bar 98, but the attractive forces are substantially less and would permit a user to open the brewer head 16 to remove and/or replace the spent beverage cartridge 32.

Alternatively, it may not be necessary to include use of the open button 102, the controller 104, the power source 106 or the coils 108. In this embodiment, the magnet 96 simply provides the requisite force to keep the lid 26 in the closed position shown in FIGS. 1 and 18 through attractive forces with the non-current induced metal bar 98. Although, preferably, the beverage brewer 10 includes some feedback mechanism to ensure that the lid 26 and the lower support member 24 are in engagement so the brew cycle can properly activate and/or deactivate. Of course, the improved beverage brewer 10 may include various combinations of the features mentioned above. For example, in one alternative embodiment, the beverage brewer 10 may include the controller 104 and the power source 106 for inducing the metal bar 98 into the electromagnet 110 during the brew cycle to ensure the lid 26 and the lower support member 24 remain engaged. Alternatively, these same features may only activate in response to depression of the open button 102 to open the lid 26, but not in response to the start of the brew cycle.

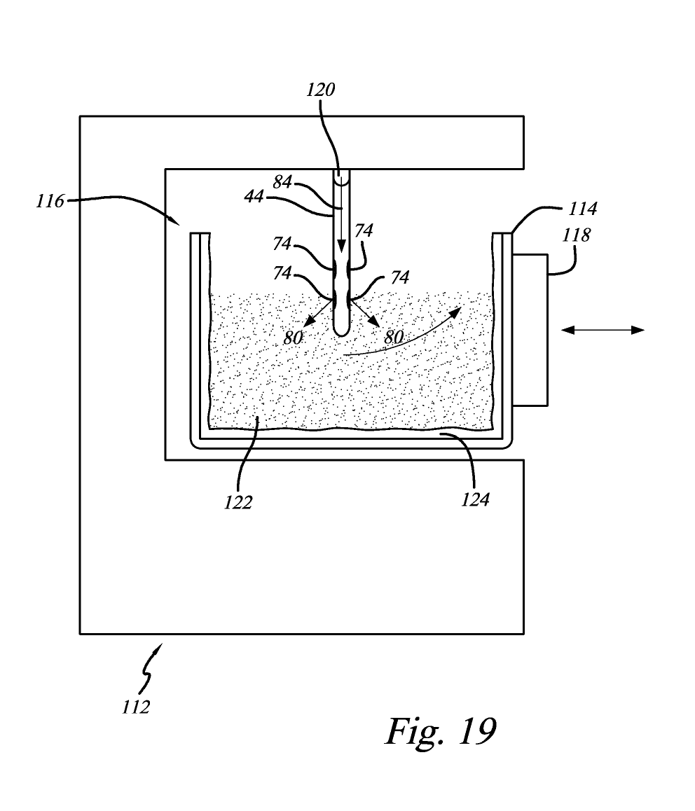

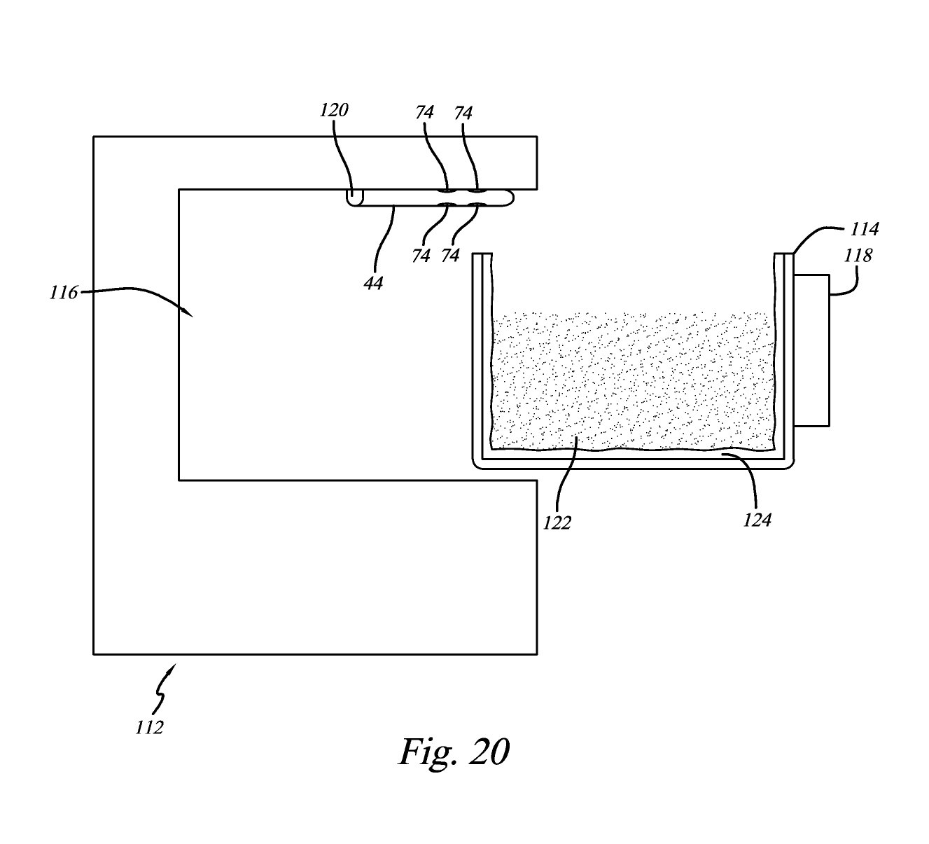

FIG. 19 illustrates a general schematic view of a commercial coffee brewer 112 designed for use with the inlet nozzle 44 as described herein. Coffee restaurant chains such as Starbucks use industrial coffee brewers to brew relatively larger quantities of coffee during a single brew cycle, as opposed to home or office coffee brewers that brew a limited quantity of coffee, e.g., a single-serve cup for an individual or several cups for a family. Such commercial coffee brewers, such as the one shown generally in FIG. 19, use a brew basket 114 that slides in and out of a brew chamber 116, such as by use of an externally accessible handle 118 or the like. The inlet nozzle 44 described herein could be integrated for use with such a commercial coffee brewer 112 by allowing the nozzle 44 to move about a hinge or pivot 120. For example, during a brew cycle, the brew basket 114 is positioned within the brew chamber 116 of the commercial coffee brewer 112 as shown in FIG. 19. Here, the inlet nozzle 44 is in a general vertical position. Preferably, any of the flow ports 74-74″″, the elongated channel 92 or the spiral channel 94 (described above) are adequately or fully immersed within the coffee grounds 122 held within a filter 124 to produce a fluidized mixture of hot water and coffee grounds 122 during a brew cycle as described herein. Of course, the inlet nozzle 44 may be disposed over the coffee grounds 122 or at least partially immersed within the coffee grounds 122, as shown in FIG. 19. In this respect, the hot water stream or spray 80 from the incoming flow 84 stirs, agitates and preferably intermixes with the coffee grounds 122 to create a fluidized mixture of hot water and coffee. The brew cycle process is similar in concept to the fluidization process described with respect to U.S. Pat. Nos. 6,968,775; 7,340,991; and 7,240,611, the contents of each being herein incorporated by reference in their entirety. At the end of the brew cycle, the inlet nozzle 44 may rotate to a non-engaged position, such as the substantially horizontal position illustrated in FIG. 20. In this position, the inlet nozzle 44 has pivoted out from engagement with the brew basket 114 such that the brew basket 114 can be pulled out from within the brew chamber 116 (e.g., use of the handle 118) so the coffee grounds 112 can be dumped out along with the filter 124 for preparation for another brew cycle. Pivoting motion of the inlet nozzle 44 may be spring, motor or mechanically activated by a linkage system.

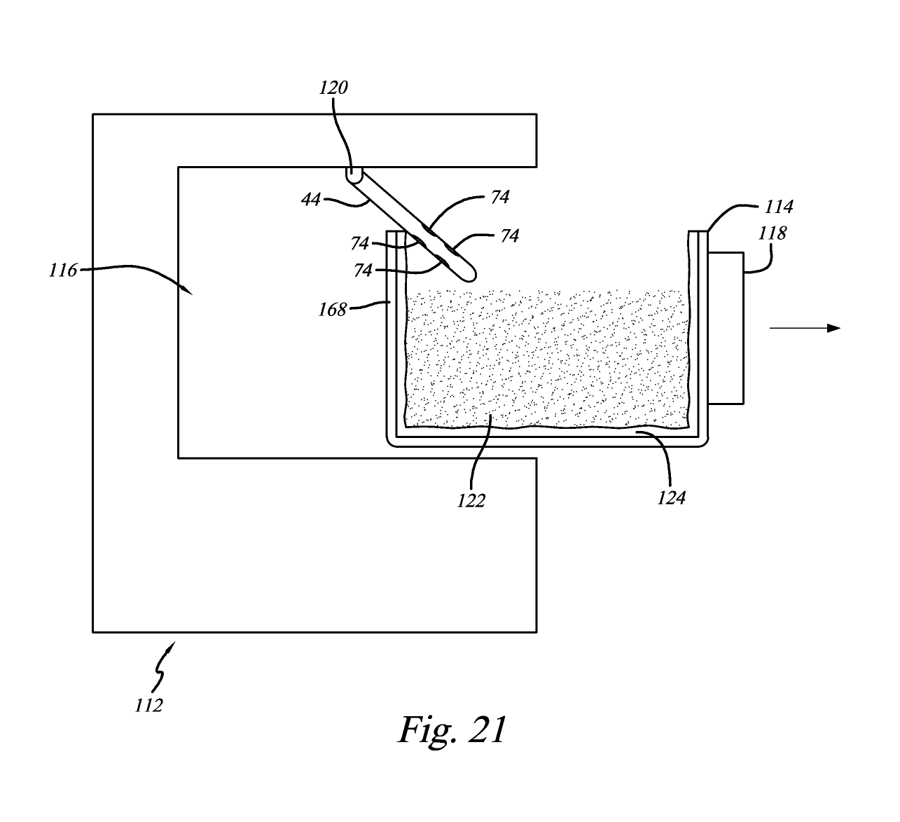

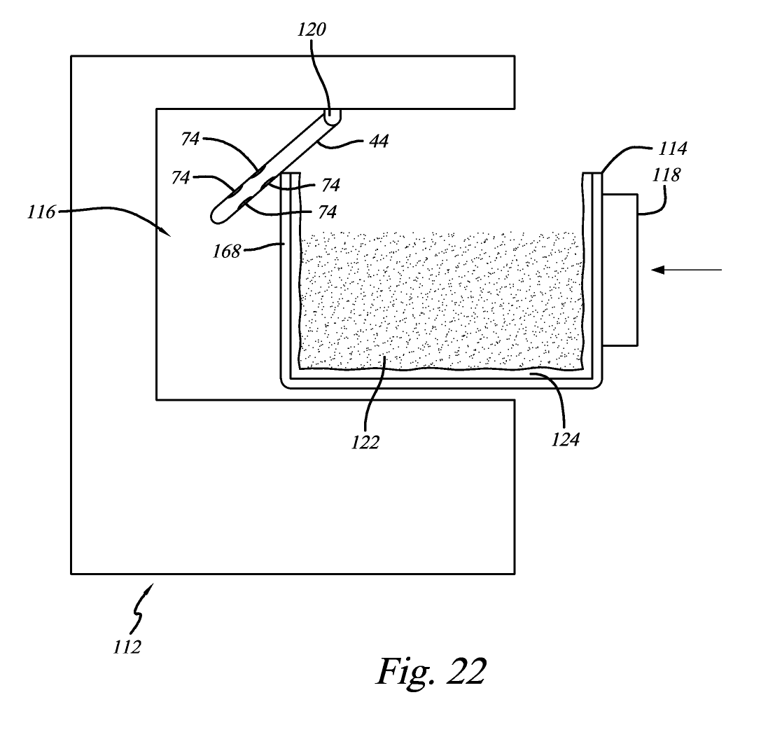

Alternatively, the inlet nozzle 44 may manually pivot from the generally vertical orientation shown in FIG. 19 to an angled position (e.g., as shown in FIG. 20) to permit removal of the brew basket 114 out from within the brew chamber 116. In one embodiment, the inlet nozzle 44 may be spring-biased into the vertical orientation shown in FIG. 19. Although, spring-biasing may not be necessary. For example, in another embodiment, the inlet nozzle 44 may be generally automatically vertically positioned (as shown in FIG. 19) as a result of the pressurized steam or spray 80 traveling therethrough during the brew cycle. In the embodiment shown in FIGS. 21 and 22, removal of the brew basket 114 is simply a matter of grabbing the handle 118 and pulling it away from the commercial coffee brewer 112. As shown, an upstanding or vertical rear wall 168 of the brew basket 114 contacts and pivots the inlet nozzle 44 counter-clockwise about the pivot 120 and into a non-engaged position when the brew basket 114 is removed from the brew chamber 116, to permit removal of the brew basket 114 out from within the brew chamber 116. Once the brew basket 114 is removed from the brew chamber 116, the inlet nozzle 44 may return back to the general vertical position shown in FIG. 19 (e.g., through use of a spring or the like). Reinserting the brew basket 114 back into the brew chamber 116, as shown in FIG. 22, involves again contacting the inlet nozzle 44 with the rear wall 168 to pivot the inlet nozzle 44 about the pivot 120 in a clockwise direction. Once the brew basket 114 is fully inserted (or nearly fully inserted), the rear wall 168 moves out from contact with the inlet nozzle 44, and the inlet nozzle 44 returns falls or is otherwise spring-biased back to the vertical position shown in FIG. 19 in preparation for another brew cycle.

In another aspect of the improved beverage brewer 10 disclosed herein, a user may be able to manually select the desired size of the beverage to be produced from the beverage cartridge 32. The beverage cartridge 32 may be of a standard size known in the art and may include a standard amount of beverage medium 78. Allowing the user to select the desired size of the beverage may be particularly desirable as it allows the user to determine the strength of the beverage. For instance, this may be particularly desirable for use with coffee cartridges. In this respect, passing less hot water through the beverage cartridge 32 will produce a relatively stronger cup of coffee than if relatively more hot water is passed through the same cartridge 32.

For example, FIG. 23 illustrates one embodiment wherein a user may select the desired quantity of beverage to be brewed from the beverage cartridge 32 (e.g., a Keurig K-cup®). Here, a user may hand manipulate an externally accessible dial 126 to set an indicator 128 to the desired quantity of the brewed beverage. In this example, the dial 126 includes settings that vary between 6 ounces and 10 ounces. Of course, the dial 126 could include a larger or smaller range of values, depending on the type of beverage brewer. In one embodiment, the indicator 128 is coupled to a wire-line controller 130 (e.g., a rheostat, potentiometer, etc.) in communication with a controller 132 that operates the brewer. Unlike conventional brewers known in the art, the wire-line controller 130 is not restricted to intermittent pre-set brew values. Rather, the wire-line controller 130 is user adjustable to the desired brew quantity, and may include values not selectable by brewers known in the art. In this respect, use of the wire-line controller 130 permits more user brew size customization regarding the specific quantity of beverage to be brewed. For example, a user is not necessarily restricted to specific brew sizes (e.g., 6 oz., 7 oz., 8 oz., 9 oz., or 10 oz.). Rather, each individual user is able to selectively position the indicator 128 at virtually any value between the minimum and maximum brew quantities (e.g., 6-10 ounces in the embodiment shown in FIG. 23). The added benefit of the wire-line controller 130 over known brewers is that the end user consumer can select intermediate values. For example, one user may enjoy coffee at a certain strength that requires 8.3 oz., as opposed to 8 oz. or 9 oz.

The controller 132 is in communication with a pump 134 that moves fluid through an outlet 136 of a water reservoir 138 to a heater 140. A flow control meter 142 may measure the quantity of water displaced in this respect. Water then flows from the heater 140, through a conduit 148 en route to the brewer head 16 to be eventually dispensed into a cup 150 as a brewed beverage. The pump 134 may be a hydraulic pump (e.g., that uses a diaphragm) that pumps a certain quantity of water from the reservoir 138 for each cycle. In this respect, the controller 132 can operate the pump accordingly. For example, if the user dials the indicator 128 to 8.3 oz., the controller 132 starts the operation of the pump 134 to draw water from the reservoir 138. The outlet 136 may include a one-way check valve to prevent backflow into the reservoir 138 during each pump cycle. The pump 134 may pump 0.25 ounces per second. In this example, therefore, the controller 132 will operate the pump 134 for approximately 33 seconds to pump 8.3 oz. from the reservoir 138 to the heater 140. Furthermore, or alternatively, the flow control meter 142 may be disposed between the pump 134 and the heater 140 to measure the quantity of water pumped therebetween. The flow control meter 142 may relay flow rate information back to the controller 132 in real-time, and the controller 132 may stop the pump 134 when the desired quantity of fluid is displaced from the reservoir 138 to the heater 140. Alternatively, in place of the flow control meter 142, the beverage brewer 10 could include a strain gauge to measure the amount of water that moves between the water reservoir 138 and the heater 140 during the brew cycle. In this embodiment, a one way check valve is preferably disposed between the strain gauge and the heater 140 to ensure that heated water does not travel back to or contact the strain gauge.

FIG. 24 is a top view of the coffee brewer lid 26, illustrating the clear housing 156 including a plurality of illuminating lights 158 that permit visual inspection and verification that the motor 52 is rotating or spinning the inlet nozzle 44 during a brew cycle. An oblong graphic 160 may spin or rotate to provide better visual indication of the brewer operation, as described above.

FIG. 25 illustrates another alternative embodiment for obtaining adequate fluidization of hot water and coffee within the beverage cartridge 32 when the nozzle 44 does not spin or rotate, as described above. Here, the cartridge 32 includes a filter 162 or the like with an upwardly projecting disperser 164 projecting into the inner chamber 50. The disperser 164 is preferably arcuate shaped or concave as shown in FIG. 25 to disperse the incoming hot water flow 84 into the interior of the chamber 50 and into contact with the beverage medium 78 as shown by the directional arrows in FIG. 25. The disperser 164 may be heat stamped inside the cartridge 32 or otherwise pushed therein by a nub 166 or other upwardly projecting article, so the disperser 164 is in a position to receive and redirect incoming water flow 84 throughout the inner chamber 50. In this embodiment, it may be possible to use inlet nozzles known in the art (e.g., stationary nozzles that emit a constant stream or spray therefrom), while still obtaining the desired fluidization within the beverage cartridge 32 to produce, e.g., a non-bitter cup of coffee having crema. The disperser 164 may be positioned above or below the filter 162 within the inside of the beverage cartridge 32.

In another aspect of the beverage brewer 10 illustrated in FIGS. 26a-26c, a locking solenoid 170 may be used to lock the brew head 16 in the closed position (e.g., shown in FIG. 1) during the brew cycle. In this respect, the locking solenoid 170 may be used to extend a horizontally oriented shaft 172 or other obstruction behind the jaw clip 36 (as shown from FIGS. 26a to 26c), thereby preventing pivoting movement of the jaw clip 36 about a latch hinge 173. More specifically as illustrated in FIG. 26a, when the beverage brewer 10 is not operating in a brew cycle, the locking solenoid 170 maintains the shaft 172 in a retracted position. In this position, the jaw clip 36 is free to pivot rearward about the hinge 173, thereby permitting a user to open the brew head 16 through depression of the release button 34, as described above. When the user initiates a brew cycle, the locking solenoid 170 extends the shaft 172 horizontally and toward the jaw clip 36. In this respect, FIG. 26b illustrates the shaft 172 partially extending out behind the jaw clip shaft 40 and FIG. 26c illustrates the shaft 172 in a fully deployed position immediately behind or in contact with the jaw clip shaft 40. In this respect, the shaft 172 obstructs rearward pivoting motion of the jaw clip 36 in the event a user attempts to open the brew head 16 with the release button 34 (or the brewer 10 is jarred in some way).

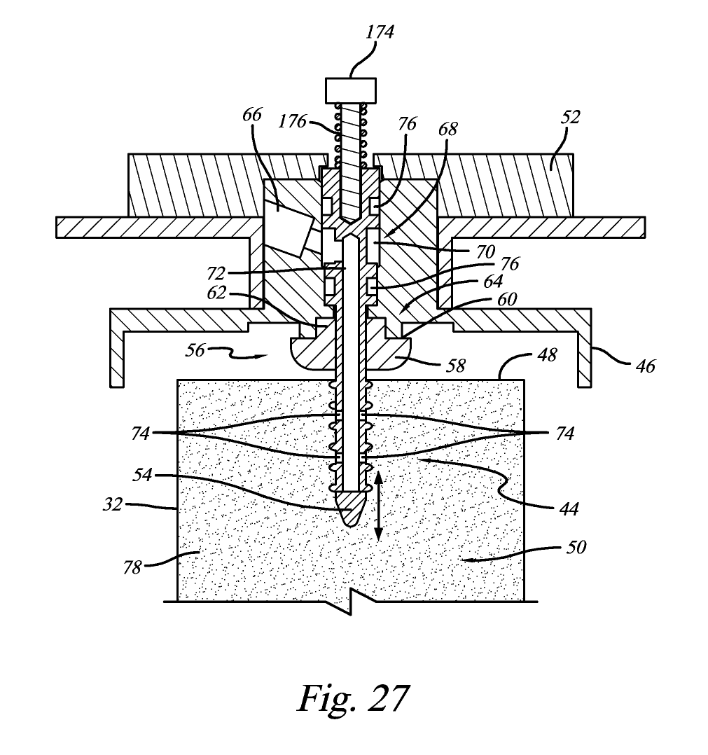

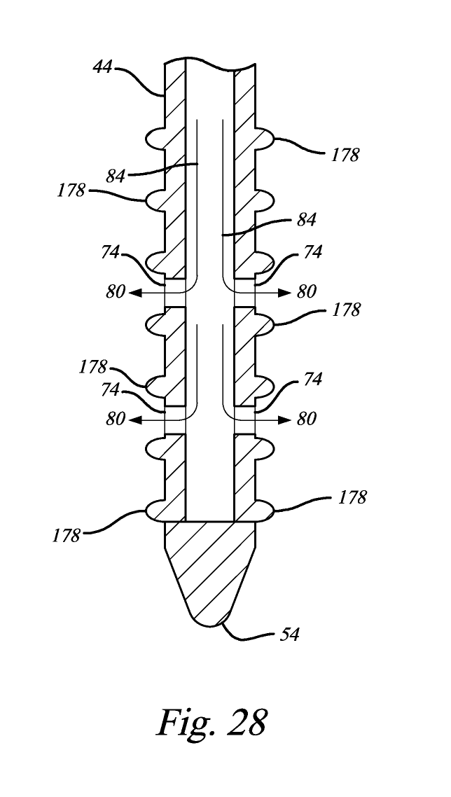

FIGS. 27 and 28 illustrate another embodiment wherein the inlet nozzle 44 vertically oscillates instead of spinning or rotating. In this embodiment, the beverage brewer 10 may include an inlet nozzle solenoid 174 that causes the inlet nozzle 44 to vertically oscillate as generally illustrated in FIG. 27. In this respect, the inlet nozzle 44 slidably attaches to the lid 26 and is generally spring-biased in an upper position. The solenoid 174 may extend an oscillation shaft 176 down into contact with the inlet nozzle 44, thereby forcing the inlet nozzle 44 downwardly against the return force of the spring and into an extended position. The solenoid 174 then retracts the shaft 176, and the spring-bias returns the inlet nozzle 44 to the upper position. In this respect, the beverage brewer 10 may pulse the solenoid 174, thereby causing the inlet nozzle 44 to move up and down at a predetermined rate. In one embodiment, the inlet nozzle 44 preferably moves up and down at a rate of 50-70 Hertz, and more preferably at a rate of 60 Hertz. Although, the inlet nozzle 44 may vertically oscillate at any rate, and the vertical oscillation rate may change during the course of a brew cycle. The beverage brewer 10 may alternately use a cam (not shown) to vertically oscillate the inlet nozzle 44 in accordance with the embodiments described herein. In another alternative embodiment, the inlet nozzle 44 may also simultaneously vertically oscillate and rotate, as described above.

FIG. 28 more specifically illustrates an alternative embodiment of the inlet nozzle 44, including a plurality of serrations 178 disposed or otherwise formed along the outer periphery thereof for agitating the beverage medium 78 in the cartridge 32. The serrations 178 preferably act as paddles that stir the beverage medium 78 and heated water in the beverage cartridge 32 during the brew cycle. Such agitation with the serrations 178 enhances fluidized mixing of the beverage medium 78 with the hot water, thereby providing a more homogeneous wetting and heating of the beverage medium 78 and more consistent flavor extraction. The serrations 178 may be any shape known in the art (e.g., rectangular, triangular, hemispherical, blade-shaped, etc.). Moreover, the serrations 178 may extend outwardly from the periphery of the inlet nozzle 44 or may be cut into the periphery thereof. Of course, the periphery of the inlet nozzle 44 may be smooth.

Preferably, in general, the beverage brewer 10 initiates water flow through the inlet nozzle 44 prior to rotation or vertical oscillation to prevent clogging any of the flow ports 74-74″″ at the start of the brew cycle. In some embodiments, the flow ports 74-74″″ may be of a shape and size that collect beverage medium 78 as the inlet nozzle 44 spins, similar to a scoop or receptacle. The collected beverage medium 78 may occlude the flow ports 74-74″″, thereby substantially occluding or otherwise preventing water from adequately exiting the inlet nozzle 44. First initiating water flow allows the pressurized water to establish an exit stream that otherwise prevents beverage medium 78 from entering the flow ports 74-74′″, to substantially reduce or eliminate the potential for the beverage medium 78 to block any one of the flow ports 74-74″″. Similarly, the beverage brewer 10 preferably stops rotation of the inlet nozzle 44 before stopping the flow of water through any of the flow ports 74-74″″ to flush any beverage medium 78 away from the flow ports 74-74″″ at the end of the brew cycle.

Although several embodiments have been described in detail for purposes of illustration, various modifications may be made without departing from the scope and spirit of the invention. Accordingly, the invention is not to be limited, except as by the appended claims.

1. A brewing system, comprising:
a water conduit system fluidly coupled to a heated water source;
a brew head in fluid communication with the water conduit system and configured to selectively receive and retain a quantity of beverage medium to be brewed by heated water delivered by the water conduit system during a brew cycle; and
a rotatable inlet nozzle fluidly coupled with the brew head and positionable therein to selectively receive and rotatably inject heated water through at least one flow port therein into the quantity of beverage medium to create a fluidized mixture of hot water and beverage medium within the brew head during the brew cycle.

2. The brewing system of claim 1, wherein the rotatable inlet nozzle is positionable within the brew head for at least partial immersion within the quantity of beverage medium during the brew cycle.

3-5. (canceled)

6. The brewing system of claim 1, including a speed controller for changing the rotational speed of the rotatable inlet nozzle.

7. The brewing system of claim 1, wherein the rotatable inlet nozzle includes a concave hollow nose for selectively reflectively dispersing heated water onto the surrounding at least partially immersed quantity of beverage medium.

8. The brewing system of claim 1, wherein the brew head includes a receptacle having a size and shape for selectively receiving and retaining a single-serve brew cartridge.

9. The brewing system of claim 1, including a solenoid for pivoting the rotatable inlet nozzle back-and-forth at intervals less than 360 degrees.

10. The brewing system of claim 1, wherein the flow port comprise s a tangential flow port, an obtusely oriented flow port, or an acutely oriented flow port.

11. (canceled)

12. The brewing system of claim 1, wherein the flow port comprises multiple flow ports staggered from one another.

13. The brewing system of claim 1, wherein the flow port emits turbulent outflow of heated water.

14-18. (canceled)

19. The brewing system of claim 1, including a view chamber permitting visual inspection of rotational movement of a motor operating the rotatable inlet nozzle.

20. The brewing system of claim 19, including at least one backlit LED illuminating the view chamber.

21-42. (canceled)

43. A method for preparing a beverage, comprising the steps of:
delivering a flow of heated water to a brewer head having an inlet nozzle in fluid communication with a quantity of beverage medium;
rotating the inlet nozzle during a brew cycle;
injecting heated water through at least one flow port in the inlet nozzle from the flow of heated water into the quantity of beverage medium to create a fluidized mixture of hot water and beverage medium within the brewer head during a brew cycle; and
dispensing a brewed beverage from the brewer head.

44-45. (canceled)
